(19) United States
(12) Patent Application Publication
(10) Pub. No.: US 2007/0041870 A1
(43) Pub. Date: Feb. 22, 2007

(54) Sensor head, gas sensor and sensor unit

(75) Inventors: Kazushi Yamanaka, Sendai-shi, Miyagi (JP); Noritaka Nakaso, Saitama (JP); Nobuo Takeda, Miyagi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Kazushi Yamanaka, Sendai-shi, Miyagi (JP); Toppan Printing Co., Ltd., Tokyo (JP); Ball Semiconductor Ltd., Nagareyama-shi, Chiba (JP)

(21) Appl. No.: 10/550,737

(22) PCT Filed: Mar. 26, 2004
(86) PCT No.: PCT/JP04/04315

§ 371 Date: Jun. 19, 2006

(30) Foreign Application Priority Data
Mar. 26, 2003 (JP) 2003-086468

(51) Int. Cl. G01N 31/22

(52) U.S. Cl. 422/58; 422/82.01; 422/98

(57) ABSTRACT

The present invention includes a three-dimensional base body (40) having a curved surface allowing definition of a circular orbital band (B), an electroacoustic transducer (21) arranged on the orbital band (B) of the three-dimensional base body (40) and configured to excite surface acoustic wave to perform multiple roundtrips along the orbital band (B), and a sensitive film (25) formed on at least a part of the orbital band (B) of the three-dimensional base body (40) and configured to react with a specific gas molecule. The surface acoustic wave experienced the multiple roundtrips along the orbital band (B) is then converted into a high frequency electric signal again by an interdigital transducer (21). The resulting high frequency electric signal is transferred to a detection/output unit (24) via a switching unit (23) and then detected by the detection/output unit (24).

### TECHNICAL FIELD

The present invention relates to a sensor head. In particular, it relates to a sensor head using a surface acoustic wave device, a gas sensor using the surface acoustic wave device, and a sensor unit assembled with the sensor head.

### BACKGROUND ART

A variety of gas sensors such as catalytic combustion sensor, a semiconductor sensor, or a surface acoustic wave sensor have been used. Of these sensors, the surface acoustic wave sensor uses a flat-plane type surface acoustic wave device as shown in FIG. 1. As shown in FIG. 1, a transmitter-side interdigital transducer 11 for exciting surface acoustic waves, a receiver-side interdigital transducer 13 serving as a piezoelectric transducer to convert the surface acoustic waves into a high frequency electric signal again, the electric signal will then be detected by an output unit 14, and a sensitive film 15 serving as a propagating path of the surface acoustic wave from the transmitter-side interdigital transducer 11 to the receiver-side interdigital transducer 13, configured to adsorb or to occlude specific gas molecules, are provided on a parallel-plate piezoelectric substrate 10.

The piezoelectric substrate 10 is made of a piezoelectric crystal such as quartz, lithium niobate (LiNbO₃), or lithium tantalate (LiTaO₃), or is implemented by a multi-layered structure, which includes a silicon substrate or a glass substrate, an oxide film formed on the silicon or glass substrate, and a thin piezoelectric film such as zinc oxide (ZnO) or aluminum nitride (AlN) formed on the oxide film. The transmitter-side interdigital transducer 11 receives a high frequency electric signal from the high frequency generator 12, and the transmitter-side interdigital transducer 11 converts the received high frequency electric signal into a surface acoustic wave, thereby exciting the surface acoustic wave. The receiver-side interdigital transducer 13 converts the surface acoustic waves into a high frequency electric signal again and transfers the high frequency electric signal to the output unit 14, which then detects the high frequency electric signal. The transmitter-side interdigital transducer 11 and the receiver-side interdigital transducer 13 are made of metallic material such as aluminum (Al) or gold (Au).

Because the flat-plane type gas sensor shown in FIG. 1 includes the sensitive film 15 configured to adsorb or occlude specific gas molecules on the propagating path of the surface acoustic wave, the propagation velocity, attenuation coefficient, dispersion of the surface acoustic wave or the like varies when specific gas molecules are adsorbed or occluded by the sensitive film 15. Alternatively, in addition to such direct variation in the propagation characteristics, the propagation characteristics are also indirectly affected by self-heating of the sensitive film 15. Accordingly, measurement of the propagation characteristic of the surface acoustic wave from the transmitter-side interdigital transducer 11 to the receiver-side interdigital transducer 13 allows measurement of adsorbed or occluded state of specific gas molecules, existence of specific gas molecules, and the density of the specific gas molecules.

Meanwhile, a study group including K. Yamanaka who is one of the inventors has reported a diffraction free propagation of multiple roundtrips of surface acoustic waves on a sphere (see page 49 of the Technical Report of Institute of Electronics, Information and Communication Engineers, Vol. US 2000, No. 14 (2000)).

### SUMMARY OF TH INVENTION

According to the flat-plane type surface acoustic device of earlier technology as shown in FIG. 1, propagation distance is limited to a short distance, or approximately one millimeter to ten millimeters, depending on diffraction effect of propagation of surface acoustic waves and the size of a piezoelectric substrate 10. Therefore, for a sensitive film 15, a certain degree of film thickness, for example, a thickness of 100 nanometers or greater is required so as to achieve sufficient sensitivity as a sensor. Accordingly, there is a disadvantage that the sensitive film 15 as a specific gas occluding thin film makes the reaction speed lower. In addition, there is a disadvantage that the thick sensitive film 15 is weak to phase transition caused by reaction of the thin film, which is ascribable to adsorption or occlusion of specific gas molecules, is weak to physical changes such as volume expansion or contraction due to change in temperature, and is weak to impacts caused by repetition of the physical changes.

It may be possible to propose a new configuration for achieving a high sensitivity, evolving the structure shown in FIG. 1, in which an additional orbital ring of surface acoustic wave waveguide is provided on a flat plane so as to increase the propagation distance. However, it is difficult for surface acoustic waves on the flat plane to completely avoid influence of dispersion, resulting in distortion of the waveform. In addition, suppressing leakage from a region of the waveguide having a large curvature formed on the flat plane is impossible, resulting in attenuation of the surface acoustic waves.

An object of the present invention is to provide a mechanically robust sensor head having high sensitivity and high-speed responsibility, a gas sensor using the sensor head, and a sensor unit on which the sensor head is assembled, considering the aforementioned problems.

In order to achieve the aforementioned object, a first aspect of the present invention inheres in a sensor head including (a) a three-dimensional base body having a curved surface allowing definition of a circular orbital band; (b) an electroacoustic transducer arranged on the orbital band of the three-dimensional base body, configured to excite surface acoustic wave to perform multiple roundtrips along the orbital band; and (c) a sensitive film at least a part of which is formed on at least a part of the orbital band of the three-dimensional base body and configured to react with a specific gas molecule. The width of the ‘orbital band’ does not always need to be completely the same value throughout the orbit, and some variation, or increase or decrease in the width thereof is allowed on a circular band. It is preferable that the ‘three-dimensional base body’ have a first curvature in a first principal direction along the orbital band central line, and a second curvature in a second principal direction perpendicular to the first principal direction. Note that the first curvature does not always need to be equal to the second curvature. The first curvature defined in the first principal direction does not always need to have a constant radius of curvature; however curvatures need to be of the same sign at least at every point on the propagating path in all directions. The second curvature defined in the second principal direction does not always need to have a constant radius of curvature; however, a topology in which a microscopically flat outer surface is formed in the vicinity of the orbital band central line when observing the cross-section along the second principal direction is allowable. In other words, a topology in which the radius of curvature is infinite in the vicinity of the orbital band central line but decreases continuously or in a stair shape with distance from the orbital band central line along the second principal direction is available. A topology such as a Japanese abacus bead having a cylindrically-shaped circumference is available. Alternatively, a topology formed by connecting the bases of two circular cones and then truncating around the circular edge formed at connected portion thereof so as to provide a cylindrically-shaped circumference having the maximum diameter may be adopted for the three-dimensional base body.

In a simple case of using a sphere as the ‘three-dimensional base body’, the width of the orbital band is determined based on the radius of the sphere and the surface acoustic wave wavelength. There is the following approximate relationship between a wavenumber parameter defined by the ratio of the circumference of the sphere and the surface acoustic wave wavelength (or product of the surface acoustic wave wavenumber and the sphere radius) and a collimation angle defined by the ratio of the orbital band width and the sphere radius (see page 49 of the Technical Report of Institute of Electronics, Information and Communication Engineers, Vol. US 2000).

TABLE 1

| Wavenumber Parameter | Collimation Angle (degree) |
|---|---|
| 150 | 15 |
| 300 | 9 |
| 450 | 8 |
| 600 | 7 |
| 750 | 6 |

According to Table 1, when a sphere of quartz (rock crystal) has a diameter of ten millimeters and the frequency is 45 MHz, the wavenumber parameter is 438, the collimation angle is approximately eight degrees, and the width of the orbital band is approximately seven hundredth the diameter. Note that since the width of the ‘orbital band’ does not always need to be completely the same value throughout orbit as described above, the collimation angle need not always be strictly constant, and some variation such as changes in the width due to anisotropy of crystal is allowable.

‘An electroacoustic transducer configured to excite a surface acoustic wave to perform multiple roundtrips along the orbital band’ should be an interdigital transducer implementing an alternate phased array. The direction in which teeth of the interdigital transducer extend is perpendicular to direction of the orbital band. The width of the orbital band is desirable to include all the length of teeth of the interdigital transducer. With such a topology, the three-dimensional base body may be a beer barrel shape, a cocoon shape, or a rugby ball shape.

As described above, a surface acoustic wave device configured to make roundtrips around a closed curved surface other than a sphere may be established under a certain condition. Although a plurality of surface acoustic waves which are generated at a single point on a curved surface other than a sphere and can spread out in a ring, may return to the same point after a single roundtrip, since each of the returning time differs depending on which propagating path is taken on the curved surface, the waveform expands along the time axis, resulting in degradation in accuracy as a sensor for measuring propagation time and variation in orbital resonance frequency. Therefore, a sphere is most appropriate as a topology of the ‘three-dimensional base body’ according to the first aspect of the present invention.

In any case, the ‘three-dimensional base body’ is not needed to be a solid massive form, and a three-dimensional shape having a hole (cavity) or a three-dimensional shape having a thick outer shell is available. Accordingly, the circular orbital band may be defined either on the surface of the outer periphery of the three-dimensional base body or surface of the inner wall of a cavity of the three-dimensional base body.

The surface acoustic waves perform multiple roundtrips along the orbital band of the three-dimensional base body according to the first aspect of the present invention with diffraction free propagation. For example, according to the measured results using a sphere of quartz having diameter of ten millimeters, the number of multiple roundtrips is 300 to 500. This means that even a smaller sphere having a diameter of one millimeter has a propagation distance equivalent to an effective length of 900 millimeters for 300 roundtrips. Accordingly, the propagation distance is longer than that of the flat (two-dimensional) plane acoustic wave device of earlier technology by approximately two orders of magnitude. This means that time resolution for measuring the propagation delay in time is improved more than the time resolution of the device of earlier technology by approximately two orders of magnitude, which leads to improvement in sensitivity.

A sensitive film according to the first aspect of the present invention reacts to specific gas molecules. In other words, adsorption, occlusion, chemical reaction, or catalytic chemical reaction of specific gas molecules occurs, resulting in change in the propagation characteristic of the surface acoustic wave. For example, when the sensitive film adsorbs specific gas molecules, mass effect by the gas molecules causes the propagation velocity of surface acoustic waves to reduce and the attenuation factor of the vibration amplitude to also decrease. Alternatively, when specific gas molecules react to the sensitive film, changing into another chemical compound, the elastic characteristics change and thereby develop change in the propagation characteristic of the surface acoustic wave. Even change in temperature due to specific gas molecules having reacted to the sensitive film, or chemical reaction occurred using the sensitive film as a catalyst causes the propagation characteristic of the surface acoustic wave to change. Accordingly, by detection of delay time of surface acoustic waves being experienced the multiple roundtrips, changes in frequency, amplitude, or output waveform, the existence of specific gas molecules and density of the specific gas molecules can be measured.

It is preferable that the thickness of the sensitive film according to the first aspect of the present invention be 100 nanoseconds or less. Since surface acoustic waves should only perform multiple roundtrips on the sensitive film, only a small amount of the sensitive film is required. Making the thickness of the sensitive film be thinner allows drastic reduction in cost. In particular, when using an occluding sensitive film, diffusion of specific gas molecules into the sensitive film s determines the response time. Therefore, the thinner the sensitive film, the shorter the response time, which facilitates an achievement of a more practical sensor. Needless to say, the same thickness may drastically increase sensitivity to be a level which could not be detected by earlier technology. In this case, a lower limit to the thickness is a value corresponding to a single molecular layer; however, a value corresponding to approximately three molecular layers or greater is preferred. Furthermore, a thin sensitive film 100 nanometers or less in thickness facilitates an achievement of a strong structure against expansion and contraction of the film due to variation in external temperature and/or variation in reaction heat temperature of the film itself, and repetitive changes in physical crystal structure due to chemical reaction or occlusion of atoms. In this case, the lower limit is a value corresponding to a single molecular layer; however, a value corresponding to approximately three molecular layers or greater is generally preferred.

In addition, it is preferable that the thickness of the sensitive film be one five hundredth of the surface acoustic wave wavelength or less. It is further preferable that the thickness of the sensitive film be one thousandth of the surface acoustic wave wavelength or less.

In addition, the sensor head according to the first aspect of the present invention is preferable when the sensitive film is a palladium (Pd) containing film. A ‘palladium (Pd) containing film’ includes a palladium alloy film such as titanium-palladium (Ti—Pd), nickel-palladium (Ni—Pd), gold-palladium (Au—Pd), silver-palladium (Ag—Pd), or gold-silver-palladium (Au—Ag—Pd) as well as a Pd film. Such a Pd containing sensitive film is particularly effective to detect hydrogen gas (H₂).

Since such a Pd containing sensitive film may be expensive, the sensitive film may be formed only on a part of the surface of the sphere, thereby reducing cost.

A second aspect of the present invention inheres in a gas sensor including (a) a three-dimensional base body having a curved surface allowing definition of a circular orbital band; (b) an electroacoustic transducer arranged on the orbital band of the three-dimensional base body, configured to excite a surface acoustic wave to perform multiple roundtrips along the orbital band and generate a high frequency electric signal from the surface acoustic wave being experienced the multiple roundtrips; (c) a sensitive film at least a part of which is formed on at least a part of the orbital band of the three-dimensional base body and configured to react with a specific gas molecule; (d) a high frequency generator configured to feed a high frequency electric signal to the electroacoustic transducer; and (e) a detection/output unit configured to measure the high frequency electric signal pertaining to propagation characteristic of the surface acoustic wave from the electroacoustic transducer.

According to the second aspect of the present invention, the high frequency generator configured to feed a high frequency electric signal to an interdigital transducer implementing the electroacoustic transducer of the sensor head described in the first aspect, and the detection/output unit configured to measure the high frequency electric signal pertaining to the propagation characteristic of the surface acoustic wave from the electroacoustic transducer are included. The detection/output unit is implemented by a detector configured to detect a high frequency electric signal received from the electroacoustic transducer and measure the changes in propagation characteristic of the surface acoustic wave such as delay time, frequency, and/or amplitude, and an output unit configured to convert the measured propagation characteristics into density of adsorbed gas molecules and to display the density or the existence of specific gas molecules. According to the gas sensor with such configuration of the second aspect of the present invention, when the sensitive film adsorbs specific gas molecules, the mass effect by the adsorbed gas molecules reduces the propagation velocity of surface acoustic waves and the attenuation factor of the vibration amplitude. Alternatively, when specific gas molecules react to the sensitive film, changing into another chemical compound, the elastic characteristics change and thereby develop change in the propagation characteristic of the surface acoustic wave. The existence of specific gas molecules and density of the specific gas molecules can be measured by the detection of delay time of surface acoustic waves being experienced the multiple roundtrips, or by the detection of changes in frequency, amplitudes, or output waveforms, because the variation of the propagation characteristic of the surface acoustic wave is generated by the variation in temperature caused by reaction of the specific gas molecules with the sensitive film, or is generated by chemical reaction of the specific gas molecules with the sensitive film, using the sensitive film as a catalyst.

According to the gas sensor of the second aspect of the present invention, utilizing a phenomenon of multiple roundtrips of surface acoustic waves, a large effective propagation length, which is larger than that of the flat plane surface acoustic wave device of the earlier technology by one order of magnitude or more, can be achieved. Because the large effective propagation length facilitates an improvement in time resolution by one order of magnitude or more, the sensitivity of the gas sensor can be increased. In addition, as described in the first aspect, when using an occluding sensitive film, because the diffusion of specific gas molecules into the sensitive film determines the response time, the thinner the sensitive film, the shorter the response time, which facilitates a realization of a more practical sensor. Furthermore, by making thin the sensitive film, a strong structure against expansion and contraction of the sensitive film due to variation in external temperature and/or variation in reaction heat temperature of the sensitive film itself, and a strong structure against repetitive changes in physical crystal structure of the sensitive film due to chemical reaction or occlusion of atoms with the sensitive film can be established.

According to the second aspect of the present invention, integration of the high frequency generator and the detection/output unit onto the three-dimensional base body allows reduction in size of the gas sensor, which is preferable.

A third aspect of the present invention inheres in a sensor unit including (a) a three-dimensional base body having a curved surface allowing definition of a circular orbital band; (b) an electroacoustic transducer arranged on the orbital band of the three-dimensional base body, configured to excite a surface acoustic wave to perform multiple roundtrips along the orbital band and generate a high frequency electric signal from the surface acoustic wave being experienced the multiple roundtrips; (c) a sensitive film at least a part of which is formed on at least a part of the orbital band of the three-dimensional base body, and configured to react with a specific gas molecule; (d) a packaging board on which the three-dimensional base body is mounted; (e) a high frequency generator arranged on the packaging board and to feed a high frequency electric signal to the electroacoustic transducer; (f) a detection/output unit arranged on the packaging board and measure the high frequency electric signal pertaining to propagation characteristic of the surface acoustic wave from the electroacoustic transducer; (g) a first board wiring arranged on the surface of the packaging board and be electrically connected to the high frequency generator; (h) a second board wiring arranged on the surface of the packaging board and be electrically connected to the detection/output unit; and (i) conductive connectors configured to electrically connect the first and the second board wirings to the electroacoustic transducer, respectively. ‘Conductive connector’ may be either of various conductive materials such as a metallic bump or a bonding wire used in semiconductor assembly process.

It is apparent from the description of the first and the second aspect that the sensor unit according to the third aspect of the present invention allows provision of a drastically improved sensor unit providing higher sensitivity and shorter response time in parallel than those of the flat plane surface acoustic wave device of the earlier technology. Moreover, a thin sensitive film facilitates an achievement of a strong structure against expansion and contraction of the film due to variation in external temperature and/or variation in reaction heat temperature of the film itself, and repetitive changes in physical crystal structure due to chemical reaction or occlusion of atoms.

A fourth aspect of the present invention inheres in a sensor unit including (a) a three-dimensional base body having a curved surface allowing definition of a circular orbital band; (b) an electroacoustic transducer arranged on the orbital band of the three-dimensional base body, configured to excite a surface acoustic wave to perform multiple roundtrips along the orbital band and generate a high frequency electric signal from the surface acoustic wave being experienced the multiple roundtrips; (c) a sensitive film at least a part of which is formed on at least a part of the orbital band of the three-dimensional base body, and configured to react with a specific gas molecule; (d) a high frequency generator configured to be integrated on the three-dimensional base body and to feed a high frequency electric signal to the electroacoustic transducer; (e) a detection/output unit integrated on the three-dimensional base body, configured to measure the high frequency electric signal pertaining to propagation characteristic of the surface acoustic wave from the electroacoustic transducer; (f) a packaging board on which the three-dimensional base body is mounted; (g) a board wiring arranged on the surface of the packaging board; and (h) a conductive connector configured to electrically connect a first board wiring to the detection/output unit. As described in the third aspect, ‘conductive connector’ may be any one of various conductive materials such as a metallic bump or a bonding wire used in semiconductor assembly process.

As with the sensor unit as according to the third aspect, the sensor unit according to the fourth aspect of the present invention facilitates an achievement of a drastically improved sensor unit providing simultaneously a higher sensitivity and a higher response time than those of the flat plane surface acoustic wave device of the earlier technology. Moreover, a thin sensitive film facilitates an achievement of a strong structure against expansion and contraction of the film due to variation in external temperature and/or variation in reaction heat temperature of the film itself, and repetitive changes in physical crystal structure due to chemical reaction or occlusion of atoms. In particular, integration of the high frequency generator and the detection/output unit onto the three-dimensional base body facilitates an achievement of a light and compact sensor unit.

### BRIEF DESCRIPTION OF THE DRAWINGS

FIG. 1 schematically shows a bird's-eye view describing a structure of a flat sensor head of earlier technology;

FIG. 2A schematically shows a bird's-eye view describing a structure of a sensor head according to a first embodiment of the present invention;

FIG. 2B is a cross-sectional view of the equator cut along the central line of a surface acoustic wave orbital band shown in FIG. 2A;

FIG. 3 is a graph describing a waveform of a delayed signal caused by multiple roundtrips of surface acoustic waves, which are measured by a detection/output unit of a gas sensor using the sensor head according to the first embodiment of the present invention;

FIG. 4A is a cross-sectional view of the equator describing a structure of a sensor head according to a second embodiment of the present invention;

FIG. 4B is a graph describing signal waveforms caused by multiple roundtrips of a surface acoustic wave, which are measured by a detection/output unit of a gas sensor using the sensor head;

FIG. 5 is a graph describing dependency of the response speed of the sensor head, according to the second embodiment of the present invention, on a gas flow rate;

FIG. 6A schematically shows a bird's-eye view describing a structure of a sensor head according to a third embodiment of the present invention;

FIG. 6B is a cross-sectional view of the equator cut along the central line of a surface acoustic wave orbital band shown in FIG. 6A;

FIG. 7 schematically shows a bird's-eye view describing a structure of a sensor head according to a fourth embodiment of the present invention;

FIG. 8 schematically shows a bird's-eye view describing a structure of a sensor head according to a first modification of the fourth embodiment of the present invention;

FIG. 9 schematically shows a bird's-eye view describing a structure of a sensor head according to a second modification of the fourth embodiment of the present invention;

FIG. 10 schematically shows a bird's-eye view describing a structure of a sensor head according to a fifth embodiment of the present invention;

FIG. 11 schematically shows a bird's-eye view describing a structure of a sensor head according to a sixth embodiment of the present invention;

FIG. 12A schematically shows a bird's-eye view describing a structure of a sensor head according to a seventh embodiment of the present invention;

FIG. 12B schematically shows a bird's-eye view describing in detail a structure of a temperature sensor of the sensor head according to the seventh embodiment of the present invention;

FIG. 12C schematically shows a bird's-eye view describing in detail a structure of another temperature sensor of the sensor head according to the seventh embodiment of the present invention;

FIG. 13 schematically shows a cross-sectional view of the equator describing a structure of a sensor head according to an eighth embodiment of the present invention;

FIG. 14 schematically shows a cross-sectional view describing a structure of a sensor unit according to a ninth embodiment of the present invention;

FIG. 15 schematically shows a bird's-eye view of multiple sensor heads (spherical surface acoustic wave devices) arranged in an array using a sensor unit assembling architecture according to the ninth embodiment of the present invention;

FIG. 16 schematically shows a cross-sectional view describing a structure of a sensor unit according to a tenth embodiment of the present invention;

FIG. 17 schematically shows a bird's-eye view of multiple sensor heads (spherical surface acoustic wave devices) arranged in an array using a sensor unit assembling architecture according to the tenth embodiment of the present invention; and

FIG. 18 schematically shows a cross-sectional view of the equator describing a structure of a sensor head according to an eleventh embodiment of the present invention.

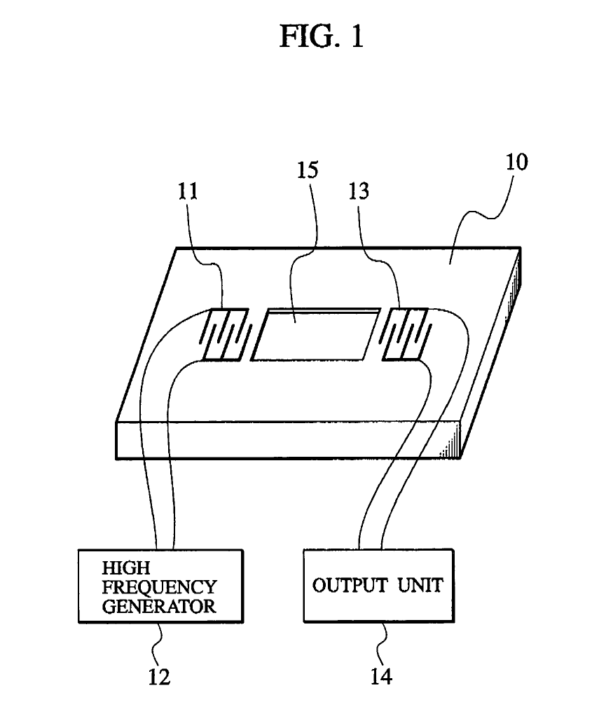

### DETAILED DESCRIPTION OF THE INVENTION

The first to eleventh embodiments of the present invention are described forthwith with reference to the accompanying drawings. The same or similar reference numerals are attached to the same or similar parts in the following drawing description. Note that those drawings are merely schematics and thus relationship between thickness of respective parts and two-dimensional size thereof may be inconsistent with reality according to the present invention. Accordingly, specific thickness and dimensional size should be determined with consideration of the following description. Moreover, it is natural that there are parts differing in relationship and ratio of dimensions among the drawings. The first to eleventh embodiments as described below exemplify apparatus or systems which embody technical ideas according to the present invention. Therefore, the technical ideas according to the present invention do not limit materials, shapes, structures, arrangements or the like of parts to those described below. The technical ideas according to the present invention may be modified into a variety of modifications within the scope of the claimed invention.

(FIRST EMBODIMENT)

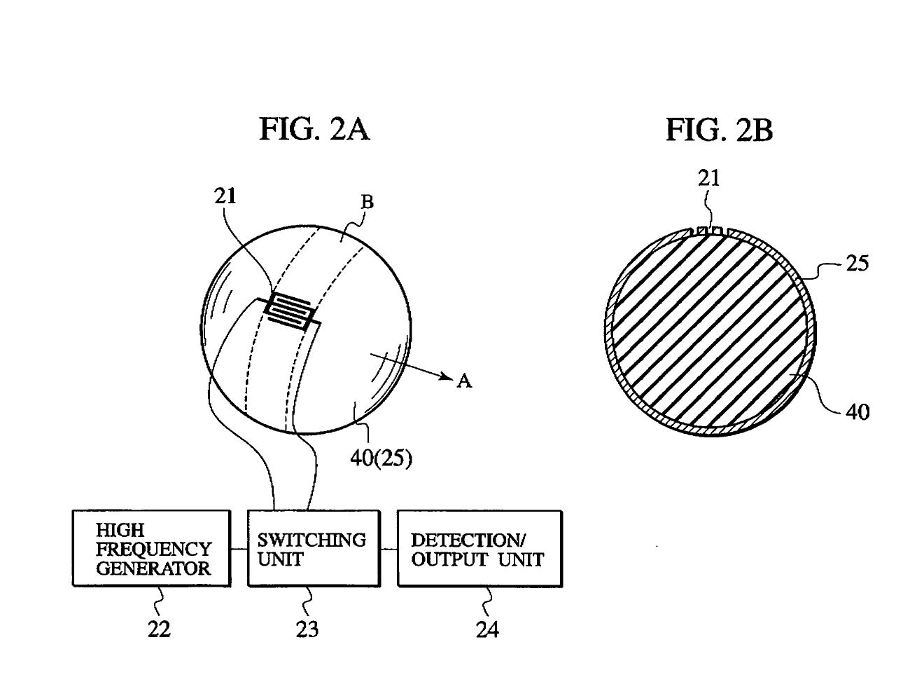

As shown in FIGS. 2A and 2B, a sensor head according to a first embodiment of the present invention encompasses a three-dimensional base body 40, which has a curved surface allowing definition of a circular orbital band B, an electroacoustic transducer 21, which is deployed on the orbital band B of the three-dimensional base body 40 and excites surface acoustic wave so as to perform multiple roundtrips along the orbital band B, and a sensitive film 25, which is formed on almost the entire surface of the orbital band B of the three-dimensional base body 40 and is configured to be reacted with specific gas molecules.

A homogeneous material sphere 40 made of piezoelectric crystal is used as the three-dimensional base body 40. A sphere of single crystal such as quartz, lithium niobate (LiNbO₃), lithium tantalate (LiTaO₃), piezoelectric ceramics (PZT), or bismuth germanium oxide (Bi₁₂GeO₂0) may be used as the homogeneous material sphere 40. The sensitive film 25 is formed on almost the entire surface of the homogeneous material sphere 40. In addition, as shown in FIGS. 2A and 2B, opening of the sensitive film 25, which causes a part of the surface of the homogeneous material sphere 40 to be exposed, is formed on a part of the equator of the homogeneous material sphere 40, and an interdigital transducer 21 is provided in the opening. Here, ‘equator’ means a line which passes through the center of the homogeneous material sphere 40 shown in FIG. 2A, and is made by a flat plane orthogonal to the direction of an arrow A and the surface of the homogeneous material sphere 40 crossing that flat plane.

In the case of a sphere of single crystal such as the homogeneous material sphere 40, a surface acoustic wave orbiting route is limited to the orbital band B depending on type of crystal material. For example, in the case of quartz, assuming that a z axis which is one of trigonal crystal axes is defined in the direction of the arrow A shown in FIG. 2A, surface acoustic waves orbit along the length of the belt-shaped orbital band B having a certain width, with the equator as the center. The width of the orbital band B may be increased or decreased depending on anisotropy of the crystal. It is desirable that the z axis of the homogeneous material sphere 40 be defined to extend in the direction of the arrow A according to the propagation characteristics of the surface acoustic wave.

The interdigital transducer 21 is a so-called alternate phased array, which serves as a piezoelectric transducer to excite surface acoustic waves by converting a high frequency electric signal supplied from a high frequency generator 22 via a switching unit 23. In addition, the interdigital transducer 21 also converts surface acoustic waves orbiting along the belt-shaped orbital band B on the equator, into a high frequency electric signal. The high frequency electric signal converted into a high frequency electric signal again by the interdigital transducer 21 is transferred to a detection/output unit 24 via the switching unit 23, and then detected by the detection/output unit 24. The switching unit 23 switches between the high frequency generator 22 and the detection/output unit 24. More specifically, the switching unit 23 transfers a high frequency electric signal from the high frequency generator 22 to the interdigital transducer 21, and then switches the signal path from the interdigital transducer 21 to the detection/output unit 24 after the interdigital transducer 21 has transmitted surface acoustic waves but before the surface acoustic waves return from being experienced a predetermined n number of roundtrips (where n is equal to or greater than 1). Alternatively, directional coupler or the like may be used to transfer in a direction from the high frequency generator 22 to the interdigital transducer 21 and then transfer in a direction from the interdigital transducer 21 to the detection/output unit 24, respectively.

A metallic film such as aluminum (Al), gold (Au), or the like may be used as the interdigital transducer 21 implementing an alternate phased array. It is desirable that the interdigital transducer 21 be made of a light-weight metallic film, which provides a low mass effect on surface acoustic waves, and that the metallic film be thinner, which allows a large number of roundtrips of surface acoustic waves along the orbital band B on the equator. Separate interdigital transducers may be provided on the transmitter-side and the receiver-side, respectively. Alternatively, for an element configured to receive the turned around surface acoustic waves, which is orbiting along the equator of the homogeneous material sphere 40, it is more effective that the single interdigital transducer 21 is time-shared, since the surface acoustic waves will return.

As shown in FIG. 2A, the longitudinal direction of the tooth of the interdigital transducer 21 used for exciting and receiving surface acoustic waves should extend along a direction perpendicular to the length of the equator on the surface of the homogeneous material sphere 40. The length of the interdigital transducer 21 may be determined based on the velocity of the surface acoustic wave, the radius of the homogeneous material sphere 40, and/or the like. Designing with an optimum length thereof facilitates the multiple roundtrips of the surface acoustic waves with a fixed width.

If the length of the interdigital transducer 21 is shorter than the optimum length, as a surface acoustic wave orbits by an angle of 90 degrees, the width of the surface acoustic wave becomes a maximum, and further orbits by 90 degrees then the width becomes the initial value. Such orbiting is then repeated. On the other hand, when the length of the interdigital transducer 21 is longer than the optimum length and the surface acoustic wave orbits by an angle of 90 degrees, the width of the surface acoustic wave becomes a minimum, and then further orbiting by 90 degrees the width becomes the initial value. Such orbiting is then repeated. Accordingly, the length of the interdigital transducer 21 may be determined based on a desired propagation path. A repetition cycle of the teeth in the interdigital transducer 21 implementing an alternate phased array is determined based on the velocity of the surface acoustic wave and the radius of the homogeneous material sphere 40 so as to obtain desired frequency characteristics. The shorter the repetition cycle of the teeth, the higher the resonance frequency of the surface acoustic wave, resulting in improvement in efficiency of mutual interaction with the surface and thereby increasing sensitivity. The higher the repetition number of the teeth in the interdigital transducer 21, the narrower the width of resonance frequency, resulting in increase in the Q value.

The sensitivity of the sensor head depends on the material and the structure of the sensitive film 25 formed on the surface of the homogeneous material sphere 40. The sensitive film 25 should be one that causes variation in the propagation characteristic of the surface acoustic wave when in contact with a specific gas. For example, making the surface of the sensitive film 25 adsorb the gas provides mass effect in the propagation characteristic of the surface acoustic wave, which may lower the propagation velocity of surface acoustic waves and/or may decrease the propagation intensity of surface acoustic waves. Alternatively, the sensitive film 25 may be one that occludes gas within and thereby changing its own mechanical stiffness and causing change in the propagation velocity and attenuation of the surface acoustic waves. Further alternatively, the sensitive film 25 may be material that reacts to gas, resulting in an endothermal or exothermal reaction, which affects the propagation velocity and attenuation of the surface acoustic waves. It is desirable that the sensitive film 25 be made of a material capable of selectively reacting to only a specific gas and reversibly reacting.

For example, palladium (Pd) configured to occlude hydrogen (H₂) so as to form hydride and to change its own mechanical property; platinum (Pt) having high adsorb capability of ammonia (NH₃); tungsten oxide (WO₃) configured to adsorb hydride; and phthalocyanine configured to adsorb selectively carbon monoxide (CO), carbon dioxide (CO₂), sulfur dioxide (SO₂), nitrogen dioxide (NO₂) or the like, are well known as materials for the such sensitive film 25.

After a surface acoustic wave is sent from the interdigital transducer 21 and then make a predetermined number of roundtrips, the sensor head of the first embodiment measures the propagation characteristics of the surface acoustic wave such as delay time and amplitude, thereby finding an adsorbed or occluded state of specific gas molecules, existence of specific gas molecules, and density of the specific gas molecules.

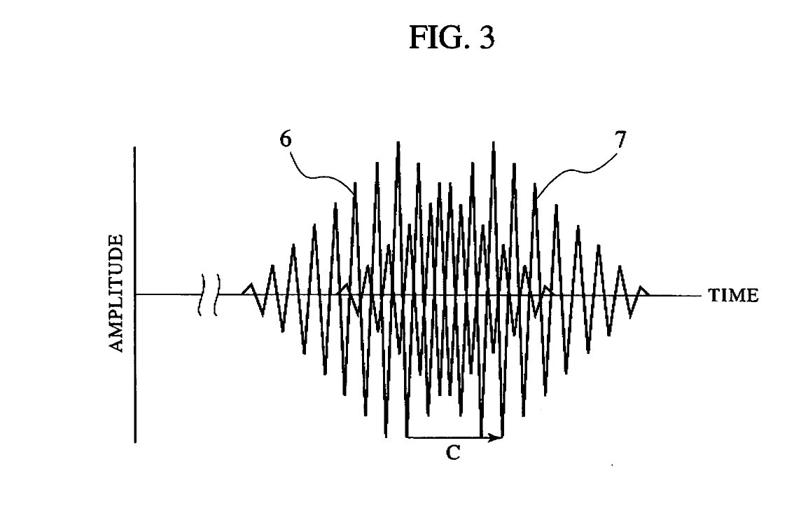

FIG. 3 is a graph showing an exemplary operation of a gas sensor using the sensor head according to the first embodiment. The abscissa represents time while the ordinate represents high frequency voltage (amplitude). A waveform 6 shown in FIG. 3 represents the surface acoustic wave having experienced a specific number of roundtrips in a predetermined time interval after the surface acoustic wave is sent at an instant when specific gas molecules were not adsorbed on the surface of the sensor head according to the first embodiment. Note that the time axis in the vicinity of the waveform, which has experienced the specific number of roundtrips, is magnified, assuming that the instant when a high frequency electric signal has excited the surface acoustic wave as zero. The magnified waveform represents a phenomenon that—for example, if a homogeneous material sphere 40 made of a quartz homogeneous material sphere has a diameter of one millimeter, it takes for a surface acoustic wave approximately one microsecond to make a single roundtrip—approximately 100 microseconds have elapsed after the excitation of the surface acoustic wave, if the instant when a high frequency electric signal has excited the surface acoustic wave is defined as zero second, and if the surface acoustic wave has just experienced the 100-th roundtrip.

When specific gas molecules are adsorbed on the surface of the sensitive film 25, the propagation velocity of surface acoustic wave decreases due to mass effect of a material being adsorbed with specific gas molecules on the surface. Accordingly, as shown with a waveform 7, an additional delay of the surface acoustic wave indicated by an arrow C occurs. Existence of specific gas molecules and the density of specific gas molecules may be measured based on whether or not there is a delay of the waveform 7 and an amount of the delay. For example, if the detection/output unit 24 is assumed to have one nanosecond (0.1%) resolution for a propagation distance of approximately three millimeters with a propagation period of one microsecond, employing the sensor head according to the first embodiment, the measurement of the surface acoustic wave with one nanosecond resolution, after 100 microseconds from the instant when the surface acoustic wave has been excited, can achieve a resolution of 10 ppm, which is one hundredth of the resolution of earlier technology.

(SECOND EMBODIMENT)

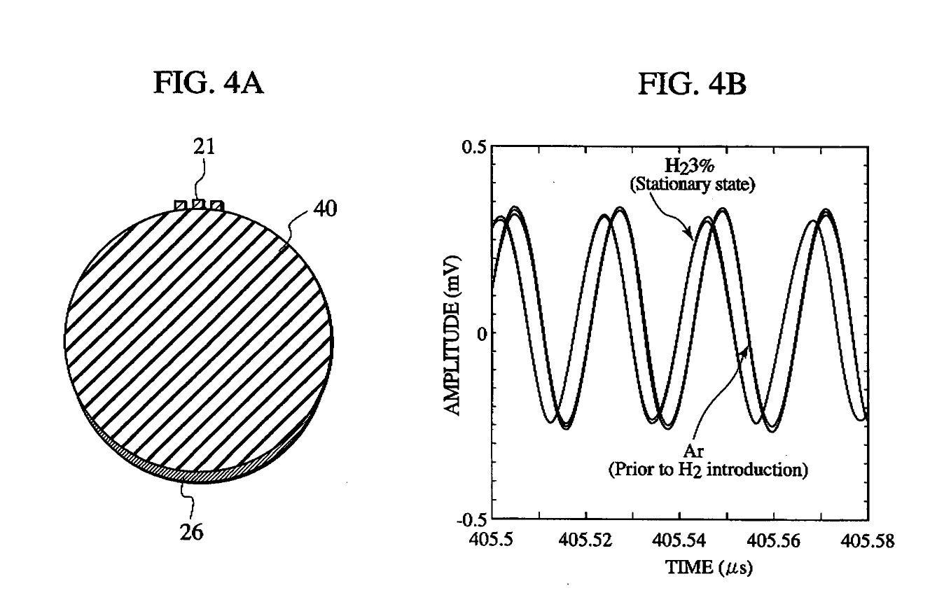

As shown in FIG. 4A, a sensor head according to a second embodiment of the present invention encompasses a three-dimensional base body 40, which has a curved surface allowing definition of a circular orbital band B, an electroacoustic transducer 21, which is deployed on the orbital band B of the three-dimensional base body 40 and excites surface acoustic wave so as to perform multiple roundtrips along the orbital band B, and a sensitive film 25, which is formed on a part of the surface of the orbital band B of the three-dimensional base body 40 and configured to react with specific gas molecules. The three-dimensional base body 40 is a homogeneous material sphere 40 as with the first embodiment, but is different from the first embodiment in that a sensitive film 26 is formed only on a part of the homogeneous material sphere 40. An interdigital transducer 21, which serves as an electroacoustic transducer 21, is formed on a part of the equator of the homogeneous material sphere 40 without the sensitive film 26.

In other words, according to the sensor head of the second embodiment, the sensitive film 26 is formed only on a part of the surface of the homogeneous material sphere 40 opposite the interdigital transducer 21. Although, as the homogeneous material sphere 40, various sphere of single crystal such as quartz, lithium niobate (LiNbO₃), or lithium tantalate (LiTaO₃) can be adopted similar to the sensor head according to the first embodiment, a case in which a quartz sphere having a diameter of ten millimeters is employed as the homogeneous material sphere 40 of the sensor head will be described in the second embodiment. The sensitive film 26 made of palladium (Pd) is deposited on a surface acoustic wave orbital band by vacuum evaporation, thereby forming a 20 nanometer-thick circular region approximately six millimeters in diameter. Since Pd selectively adsorbs only hydrogen and forms a hydrogen alloy, it may be used as a hydrogen gas sensor having extremely favorable selectivity. In addition, since Pd can be formed only on a surface of a spherical surface acoustic wave device through vacuum evaporation after formation of the interdigital transducer 21 and assembly process, the fabrication of the sensor head of the second embodiment is easy.

If the material of the sensitive film 26 such as Pd is expensive, as shown in FIGS. 4A and 4B, formation of the sensitive film 26 only on a part of the surface of the sphere requires a very small amount of sensitive film 26, resulting in a drastic reduction in cost. Accordingly, the sensor head according to the second embodiment achieves a significant industrial advantage.

FIG. 4B is a graph showing waveforms of signals measured by a detection/output unit 24 of the sensor head according to the second embodiment. The ordinate represents detected high frequency amplitude while the abscissa represents elapsed time. The signal at 41-st roundtrip (approximately 400 microseconds) is measured under the condition that exciting frequency of the surface acoustic wave is approximately 45 MHz, and a single roundtrip time of the surface acoustic wave orbiting the quartz homogeneous material sphere 40 having a ten millimeters diameter is approximately ten microseconds. FIG. 4B shows a waveform in 100% argon gas ambient prior to the induction of hydrogen gas and a waveform after 3% hydrogen gas was induced, respectively. Since Pd adsorbs hydrogen so as to form a hydride so that the mechanical stiffness of Pd increases, the surface acoustic wave propagation velocity becomes faster and thus delay time decreases. The delay time decreases by approximately three nanoseconds (i.e., approximately 7 ppm) when 3% hydrogen is induced.

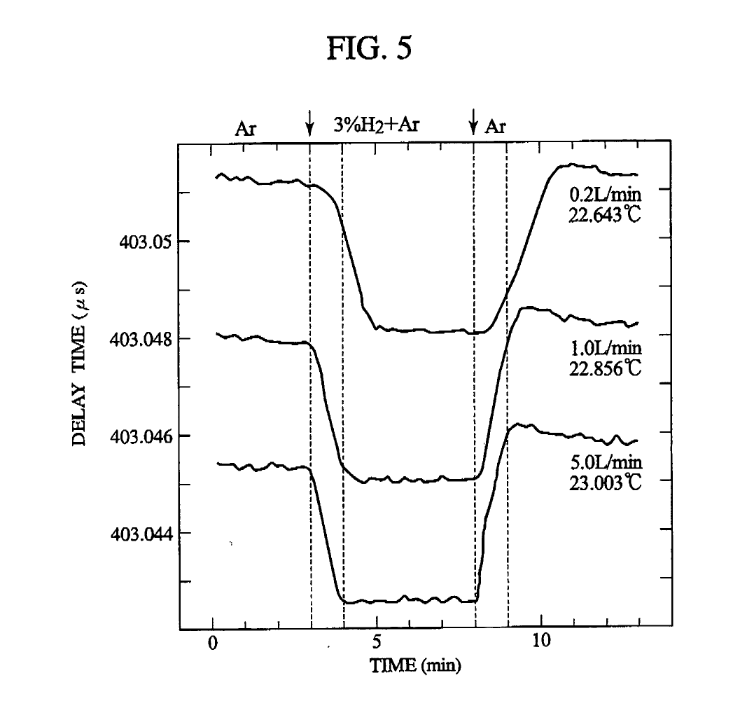

FIG. 5 is a graph showing hydrogen gas sensor characteristics evaluated using an acrylic cylinder flow cell. In FIG. 5, the ordinate represents the delay time of surface acoustic wave while the abscissa represents elapsed time. Pure Ar gas is introduced at a time zero, Ar gas containing 3.0 vol % hydrogen is introduced at a time of three minutes, and then, pure Ar gas is introduced at a time of eight minutes. The gas flow rate is changed to 0.2 L/ min, 1.0 L/ min, and 5.0 L/ min in turn. As the gas flow rate increases, faster gas replacement within the flow cell is carried out, resulting in saturation in a response time of approximately 60 seconds. The time interval until the saturation in the response time is generated may be the time interval required for diffusion of hydrogen within Pd, and the response speed of the sensor head according to the second embodiment is one fourth of or less the response speed of a hydrogen gas sensor (190 nanometers in Pd film thickness) using the flat-plane type surface acoustic wave device of earlier technology. The improvement of the response speed is mainly ascribable to the fact that the thickness of the Pd film, which serves as the sensitive film 26, is approximately one tenth of the film thickness of the surface acoustic wave device of earlier technology.

Critical sensitivity of the sensor head according to the second embodiment to hydrogen is described forthwith. The waveform at the 41-st roundtrip is subjected to wavelet transformation using, as a mother wavelet, the Gabor function, which is superior in time resolution and frequency resolution, so as to evaluate the response time to hydrogen. In a time interval between 403.040 seconds and 403.060 seconds, an instant that will make real part of the result of wavelet transformation maximum is searched, and the searched instant is then employed so as to define a delay time. While a sampling time of 0.5 nanosecond is used for measurement, significant change is observed at a resolution of 0.025 nanosecond when interpolation is carried out at time interval of 0.025 nanosecond through wavelet analysis. On the other hand, since the entire delay time is 403 microseconds, relative time accuracy is 0.025/403000=60 ppb. This corresponds to 30 ppm when converted to hydrogen gas density. This means that if the number of roundtrips is 300, hydrogen density accuracy of a ppm order can be expected. Alternatively, making the Pd film be thinner while keeping a fixed sensitivity will allow further reduction in the response time. Diffraction free propagation of an ultra great number of multiple roundtrips, which is a characteristic specific to surface acoustic wave orbiting the homogeneous material sphere 40, can achieve measurement with such ultimate high accuracy.

Catalytic combustion type and semiconductor type hydrogen gas sensors are presently available on the market. The catalytic combustion type has a problem of selectivity because it responds to combustion gas except for hydrogen. In addition, the catalytic combustion type may be used only for high density ambient, and in contrast, the semiconductor type may be used only for low density ambient. Therefore, measurement in a wide density range is impossible. As described above, the hydrogen gas sensor using a flat-plane type surface acoustic wave device has a problem of response time. Accordingly, while there have been no hydrogen gas sensors that can simultaneously satisfy all of requirements in selectivity, sensitivity, dynamic range, and response time, the sensor head according to the second embodiment provides an excellent hydrogen gas sensor simultaneously satisfying all of the requirements, having a superior selectivity, a sensitivity of ppm order, a dynamic range of up to several percentages, and a response time of 60 seconds or less.

(THIRD EMBODIMENT)

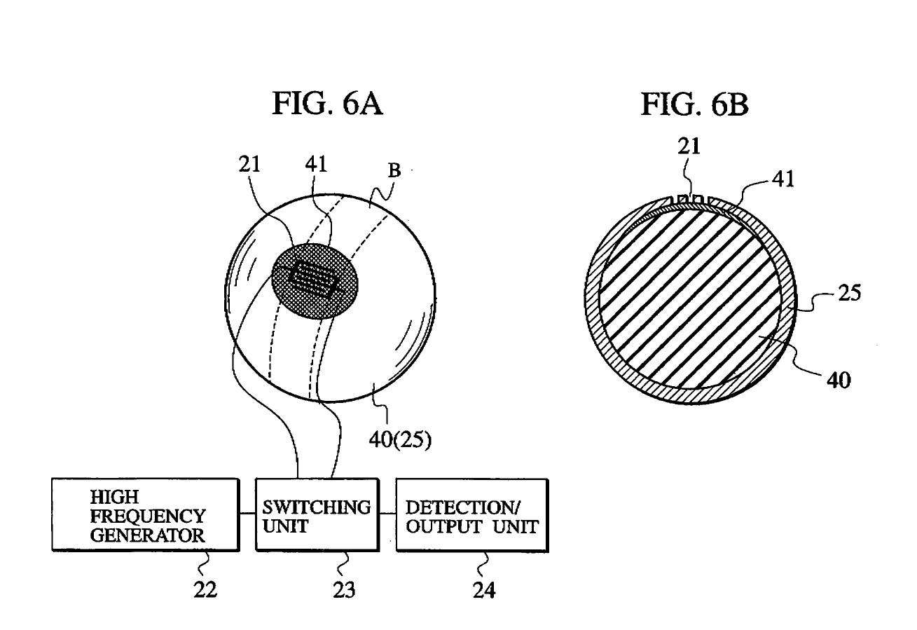

As shown in FIGS. 6A and 6B, a sensor head according to a third embodiment of the present invention includes a thin piezoelectric film 41 formed on at least a part of the surface of a homogeneous material sphere 40 made of a material having homogeneous elastic characteristics. It is different from the first and second embodiments in that the homogeneous material sphere 40 may be made of a material without piezoelectricity (non-piezoelectric material) since the thin piezoelectric film 41 is formed on the surface of the homogeneous material sphere 40. Therefore, the homogeneous material sphere 40 may be made of an amorphous material such as borosilicate glass, and a glass material such as quartz glass. The thin piezoelectric film 41 may be made of cadmium sulfide (CdS), zinc oxide (ZnO), zinc sulfide (ZnS), or aluminum nitride (AlN), and may he deposited on the surface of the homogeneous material sphere 40 through well-known sputtering or vacuum evaporation.

A sensitive film 25 is formed on the surface of the homogeneous material sphere 40 and the thin piezoelectric film 41. The thin piezoelectric film 41 may be formed only in the vicinity of an interdigital transducer 21 used for exciting and receiving surface acoustic wave. Only forming the interdigital transducer 21 directly on the surface of a non-piezoelectric material cannot excite the surface acoustic wave. This is because the homogeneous material sphere 40 is not deformed even when an electric field is applied. Accordingly, surface acoustic wave can be excited and received as long as the thin piezoelectric film 41 is formed at least only in the vicinity of the interdigital transducer 21 such as directly beneath or directly over the interdigital transducer 21. A high frequency generator 22, a switching unit 23, and a detection/output unit 24 are the same as those respective units of the sensor head according to the first embodiment, and thus repetitive description thereof is omitted.

FIG. 6B shows a cross-sectional structure of the sensor head according to the third embodiment shown in FIG. 6A. Design of the interdigital transducer 21 is the same as that of the sensor head according to the first embodiment. In the cross-sectional view shown in FIG. 6B, the interdigital transducer 21 is formed on the thin piezoelectric film 41; however, the position of the interdigital transducer 21 is not limited to the configuration shown in FIG. 6B. For example, the interdigital transducer 21 may be formed between the homogeneous material sphere 40 and the thin piezoelectric film 41, or a pair of interdigital transducers 21 sandwiches the top and the bottom of the thin piezoelectric film 41. In either case, a surface acoustic wave orbital band B extends along a direction perpendicular to the longitudinal direction of the tooth of the interdigital transducer 21, and an arbitrary direction may be selected for the band.

The sensitivity of the sensor head depends on the material and the structure of the sensitive film 25 formed on the surface of the homogeneous material sphere 40. The sensitive film 25 should be made of material that causes variation in the propagation characteristic of the surface acoustic wave when in contact with a specific gas. For example, the sensitive film 25 may be made of material, which will lower the propagation velocity of surface acoustic wave, and/or will decrease the propagation intensity of surface acoustic wave by mass effect ascribable to the adsorption of the gas on the surface of the sensitive film 25. Alternatively, the sensitive film 25 may be made of material that occludes gas within and thereby changing its own mechanical stiffness and causing change in the propagation velocity and attenuation of the surface acoustic wave. Further alternatively, the sensitive film 25 may be made of material that reacts to gas, resulting in an endothermal or exothermal reaction, which affects the propagation velocity and attenuation of the surface acoustic wave. It is desirable that the sensitive film 25 be made of a material capable of selectively reacting to only a specific gas and reversibly reacting.

(FOURTH EMBODIMENT)

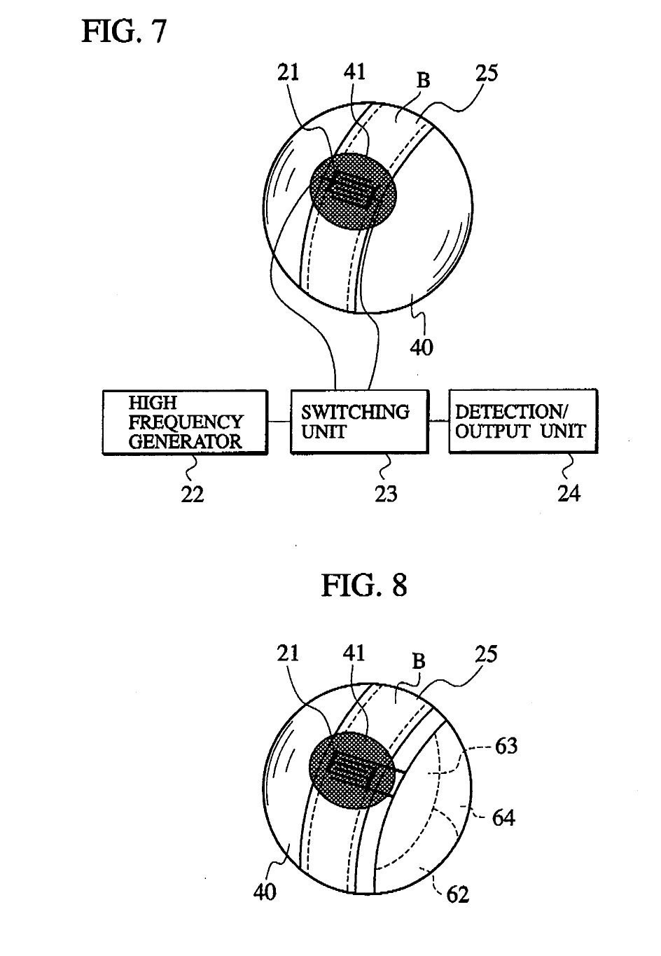

As shown in FIG. 7, a sensor head according to a fourth embodiment of the present invention includes a sensitive film 25 formed only on a surface acoustic wave orbital band B. A thin piezoelectric film 41 is formed on at least a part of the surface of a homogeneous material sphere 40 made of a material having homogeneous elastic characteristics. The thin piezoelectric film 41 is formed only in the vicinity of an interdigital transducer 21 used for exciting and receiving the surface acoustic wave. The orbital band B for the surface acoustic wave extends along a direction perpendicular to the longitudinal direction of the tooth of the interdigital transducer 21. A high frequency generator 22, a switching unit 23, and a detection/output unit 24 are the same as those respective units of the sensor head according to the first and third embodiments, and thus repetitive description thereof is omitted.

A sensitive film 25 of the sensor head according to the fourth embodiment is formed only in the vicinity of the orbital band B for the surface acoustic wave. Although the sensitive film 25 needs to be delineated, there is an advantage that an area of the surface on which the sensitive film 25 is not formed can be used for other purposes.

If the material of the sensitive film 25 such as Pd is expensive, as shown in FIG. 7, formation of the sensitive film 25 only on the surface of the orbital band B requires a very small amount of sensitive film 25, resulting in a drastic reduction in cost. Accordingly, the sensor head according to the fourth embodiment achieves a significant industrial advantage.

FIG. 8 schematically shows an exemplary structure in which a high frequency generator 62, a switching unit 63, and a detection/output unit 64 are integrated onto the surface of a homogeneous material sphere 40, as a sensor head according to a first modification of the fourth embodiment. As with FIG. 7, a thin piezoelectric film 41 is formed at least on a part of the surface of the homogeneous material sphere 40. The thin piezoelectric film 41 is formed only in the vicinity of an interdigital transducer 21 used for exciting and receiving the surface acoustic wave, and a surface acoustic wave orbital band B extends along a direction perpendicular to the longitudinal direction of the tooth of the interdigital transducer 21. Since a sensitive film 25 is formed only in the vicinity of the orbital band B for the surface acoustic wave, other circuits can be formed on other areas.

It is desirable that the homogeneous material sphere 40 shown in FIG. 8 be a silicon sphere 40 on which an oxide film is formed. With ensuring approximate homogeneity for surface acoustic wave propagation using an oxide film, by selectively removing the oxide film except for the area in which the sensitive film 25 is scheduled to be formed, adapting a technique for manufacturing spherical semiconductor devices, it is possible to merge various circuits, such as the high frequency generator 62, the switching unit 63, and the detection/output unit 64, as well as a high frequency circuit and/or other integrated circuits in the areas not contributing to surface acoustic wave propagation so as to fabricate a smaller gas sensor.

Needless to say, the homogeneous material sphere 40 may be made of a glass material such as borosilicate glass or quartz glass. A thin polycrystalline silicon film or a thin amorphous silicon film may be deposited on the area where the high frequency circuit or the integrated circuit is scheduled to be formed. Afterwards, a thin-film transistor may be formed on the polycrystalline or amorphous silicon film. The thin polycrystalline silicon film and the thin amorphous silicon film may be used after they are changed to single crystal silicon by thermal treatment or laser annealing. Needless to say, the methodology depositing a new thin film may be applied to a sensor head using the homogeneous material sphere 40.

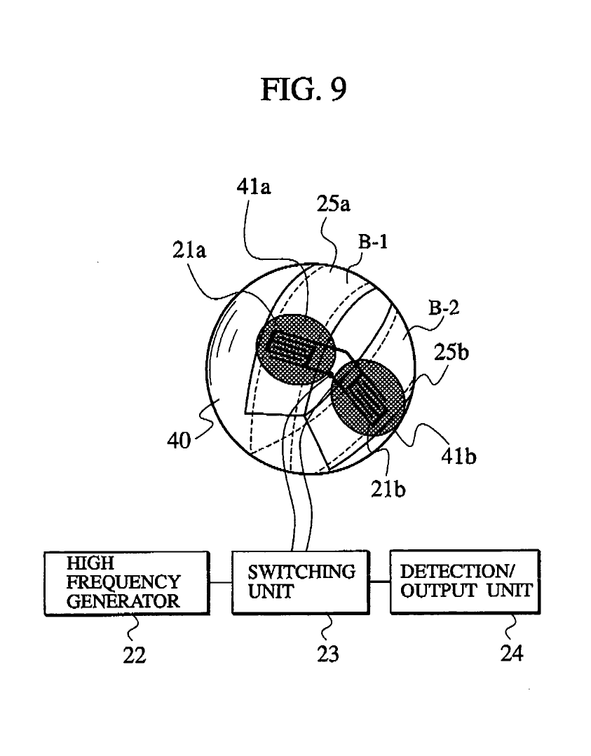

FIG. 9 schematically shows an exemplary structure of a sensor head according to a second modification of the fourth embodiment, which includes surface acoustic wave orbital bands B-1 and B-2, and different sensitive films 25a and 25b along with the respective orbital bands B-1 and B-2 so as to measure various types of gas at the same time. Thin piezoelectric films 41a and 41b are formed at least on a part of the surface of the homogeneous material sphere 40. The thin piezoelectric films 41a and 41b are formed only in the vicinity of interdigital transducers 21a and 21b used for exciting and receiving the surface acoustic wave, and the surface acoustic wave orbital bands B-1 and B-2 extend along a direction perpendicular to the longitudinal directions of the teeth of the interdigital transducers 21a and 21b. The interdigital transducers 21a and 21b are provided so as to minimize overlapping of the respective orbital bands B-1 and B-2. The sensitive films 25a and 25b are formed only in the vicinity of the orbital band B for the surface acoustic wave. Use of different types for the respective sensitive films 25a and 25b allows measurement of different types of gas. Needless to say, the same sensitive film may be used, and detection results from the respective orbital bands B-1 and B-2 may be averaged for increasing accuracy. Alternatively, combination of a relatively thick sensitive film focusing on measurement sensitivity and a relatively thin sensitive film focusing on reaction speed may be used.

A structure implemented by a high frequency generator 22, a switching unit 23, and a detection/output unit shown in FIG. 9 is almost the same as that of the sensor head according to the first and third embodiments; however, it is different in that the switching unit 23 is connected to both of the interdigital transducers 21a and 21b. If the sensitive films 25a and 25b are different from each other, propagation characteristic of the surface acoustic wave are also different when there is no target measurement gas as a reference. This allows time-shared measurement.

In addition to the circuit configuration disclosed above, with multiple orbital bands B-1 and B-2 as shown in FIG. 9, another circuit configuration such that, from a single switching unit, two separate wirings are respectively connected to two separate interdigital transducers so as to perform alternated time-shared measurement.

In addition, while FIG. 9 shows two orbital bands B-1 and B-2, an increased number of orbital bands B-1, B-2, B-3 . . . may be established by optimizing the length of the interdigital transducers 21a and 21b so as to control the width of each of the surface acoustic wave orbital bands B-1 and B-2 such that each of the surface acoustic wave orbital bands B-1 and B-2 has an unchanged width, the width can be controlled to be approximately one tenth of the diameter of the homogeneous material sphere 40 at most. For example, if it is necessary to measure existence of multiple kinds of gas molecules and density thereof at the same time for measurement of odor or the like, a structure including an increased number of orbital bands B-1, B-2, B-3, . . . is particularly effective.

(FIFTH EMBODIMENT)

Since a sensor head of the present invention utilizes propagation characteristic of the surface acoustic wave, the performance of the sensor head is influenced by ambient temperature. Therefore, it is desirable that correction of temperature should be carried out.

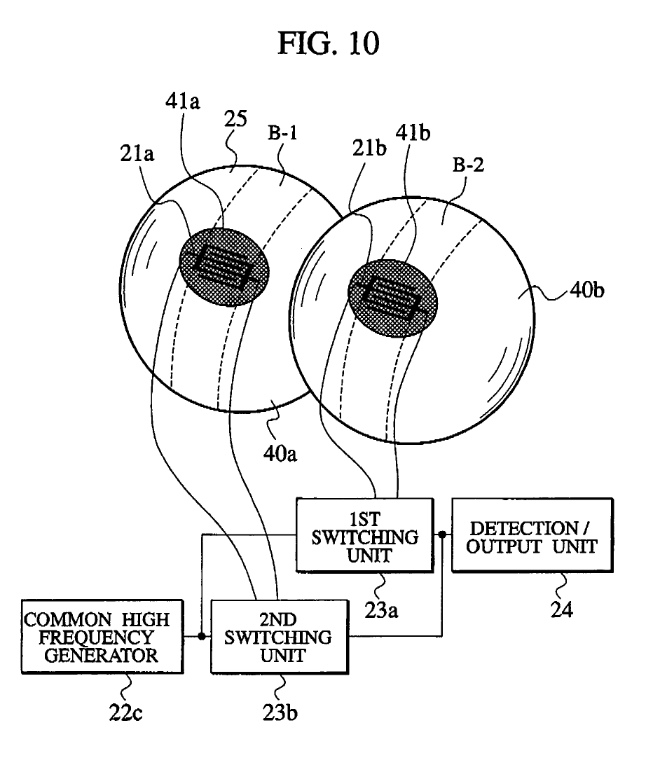

FIG. 10 schematically shows an exemplary structure encompassing two different homogeneous material spheres 40a and 40b, which are used for correction of temperature. Thin piezoelectric films 41a and 41b are formed on at least a part of the respective homogeneous material spheres 40a and 40b made of a material having homogeneous elastic characteristics. The thin piezoelectric films 41a and 41b are formed only in the vicinity of the interdigital transducers 21a and 21b used for exciting and receiving the surface acoustic wave, and the surface acoustic wave orbital bands B-1 and B-2 extend along a direction perpendicular to the longitudinal direction of the tooth of the interdigital transducers 21a and 21b. A sensitive film 25 is formed only on the homogeneous material sphere 40a, but not on the homogeneous material sphere 40b. One of the surface acoustic wave devices operates in the same manner as the aforementioned sensor head according to the first embodiment, due to existence of the sensitive film 25. On the other hand, in the other surface acoustic wave device, the propagation characteristic of the surface acoustic wave is influenced only by temperature since the sensitive film 25 is not formed.

The configuration encompassing a high frequency generator 22c, switching units 23a and 23b, and a detection/output unit 24 shown in FIG. 10 is almost the same as the configurations of the sensor heads according to the first, third, and fourth embodiments; however, it is different in that a high frequency electric signal generated by the common high frequency generator 22c is divided into two and simultaneously coupled to respective interdigital transducers 21a and 21b via connection switching units 23a and 23b. Respective delayed signals of the homogeneous material spheres 40a and 40b are transmitted to the detection/output unit 24 via the connection switching units 23a and 23b. By measuring the difference in delay times of surface acoustic waves generated in each of the homogeneous material spheres 40a and 40b at all times, the influence of temperature can be compensated so as to achieve a measurement with a high accuracy.

According to the sensor head pertaining to the fifth embodiment, because the same two homogeneous material spheres 40a and 40b except for existence of a sensitive film are employed so that the difference between two signals obtained from two homogeneous material spheres 40a and 40b can be measured so as to remove directly the influence of temperature, the temperature correction becomes easy.

(SIXTH EMBODIMENT)

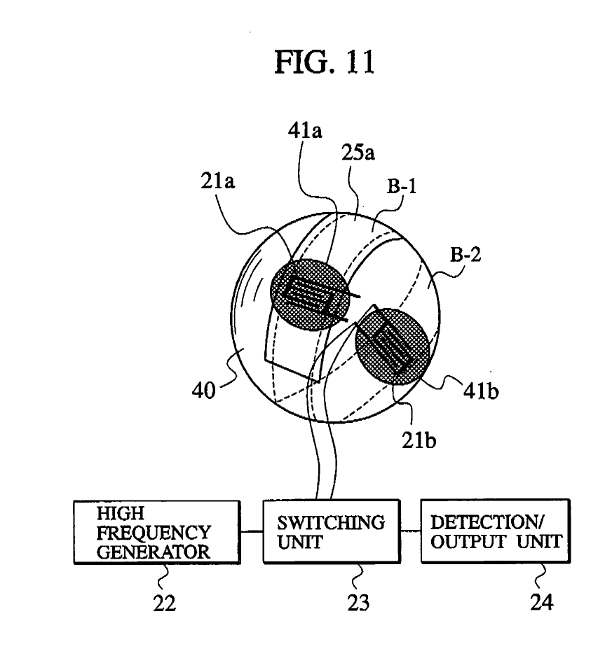

FIG. 11 shows an exemplary temperature calibration methodology using two different surface acoustic wave orbital bands B-1 and B-2 according to a sensor head of a sixth embodiment of the present invention. Thin piezoelectric films 41a and 41b are formed on at least parts of the surface of a homogeneous material sphere 40. The thin piezoelectric films 41a and 41b are provided only in the vicinity of interdigital transducers 21a and 21b configured to excite and receive the surface acoustic wave. The surface acoustic wave orbital bands B-1 and B-2 extend along directions perpendicular to the longitudinal directions of the teeth of the interdigital transducers 21a and 21b, respectively. The interdigital transducers 21a and 21b are provided so as to minimize overlapping of the respective orbital bands B-1 and B-2. A sensitive film 25 is formed only in the vicinity of the orbital band B for the surface acoustic wave-1.

A structure including a high frequency generator 22, a switching unit 23, and a detection/output unit 24 of the gas sensor according to the sixth embodiment is almost the same as that of the aforementioned sensor head according to the first and third embodiments; however, it is different in that the switching unit 23 is connected to both of the interdigital transducers 21a and 21b. Since the sensitive film 25 is formed only for the orbital band B for the surface acoustic wave-1 but not for the other band, continuous measurement of difference in delay time of the surface acoustic wave by the detection/output unit 24 suppresses influence of temperature, thereby measuring with high accuracy.

According to the sensor head of the sixth embodiment, because the sensor head encompasses two orbital bands B-1 and B-2 spatially close to each other over the same homogeneous material sphere 40, and a temperature measurement means using the same measurement methodology, the accuracy of the temperature correction becomes extremely high.

(SEVENTH EMBODIMENT)

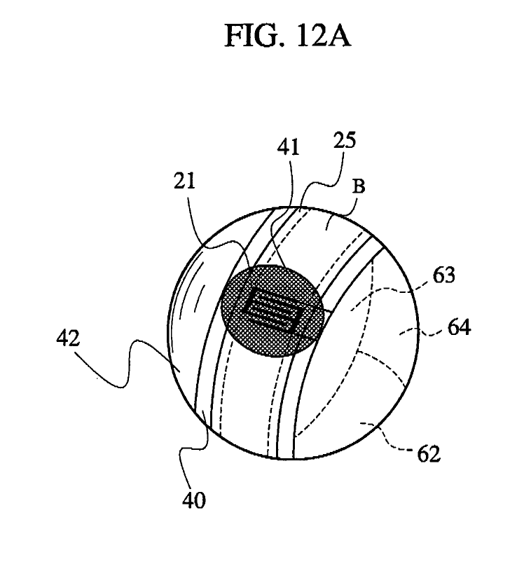

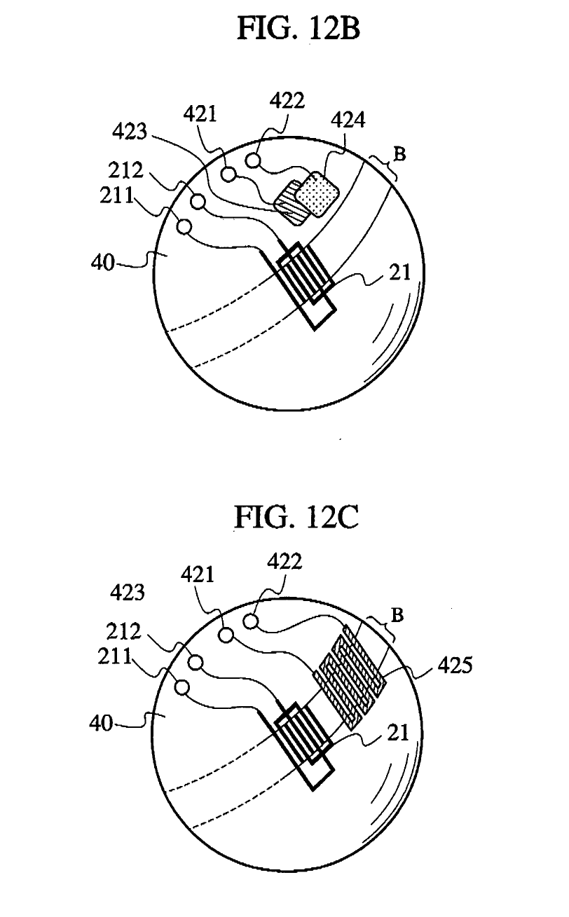

As shown in FIG. 12A, a sensor head according to a seventh embodiment of the present invention encompasses a temperature sensor 42 on a homogeneous material sphere 40. A thin piezoelectric film 41 is formed on at least a part of the homogeneous material sphere 40. The thin piezoelectric film 41 is formed only in the vicinity of an interdigital transducer 21 configured to excite and receive the surface acoustic wave. A surface acoustic wave orbital band B extends along a direction perpendicular to the longitudinal direction of the tooth of the interdigital transducer 21. Since a sensitive film 25 is formed only in the vicinity of the surface acoustic wave orbital band, other circuits can be formed on the remaining areas of the surface acoustic wave orbital band.

Therefore, according to the sensor head of the seventh embodiment, a high frequency generator 62, a switching unit 63, and a detection/output unit 64 can be integrated onto the remaining areas of the surface of the homogeneous material sphere 40.

In addition, according to the sensor head of the seventh embodiment, the temperature sensor 42 is provided away from the orbital band B for the surface acoustic wave. Various types of temperature sensors such as a thermocouple, a resistance-thermometer type temperature sensor, or a semiconductor temperature sensor may be used as the temperature sensor 42. Since the temperature sensor 42 is provided extremely close to the orbital band B for the surface acoustic wave, temperature calibration accuracy is high.

FIG. 12B shows an exemplary sensor head using a thermocouple 42. A first metallic film 423 pattern and a second metallic film 423 pattern are formed partially overlapping each other and extremely close to the orbital band B on the surface of the homogeneous material sphere 40, implementing a temperature measuring unit (temperature measuring contact), from which wiring patterns are delineated up to bonding pads 421 and 423. As shown in FIG. 12B, the interdigital transducer 21 is formed on a part of the surface of the orbital band B, and is connected to bonding pads 211 and 212. A high frequency electric signal is supplied from a high frequency generator on a packaging board omitted in the drawing via the bonding pads 211 and 212. The supplied high frequency electric signal is then converted using a piezoelectric transducer, thereby exciting surface acoustic wave. In addition, the interdigital transducer 21, serving as a piezoelectric transducer, converts the surface acoustic wave which has orbited along the belt-shaped orbital band B on the equator into a high frequency electric signal again, the electric signal again is then transferred to a detection/output unit on the packaging board, not shown in the drawing, via the bonding pads 211 and 212, and detected by the detection/output unit.

It is preferable that the wiring pattern of the temperature sensor up to the bonding pad 421 shown in FIG. 12B be made of the first metallic film 423. Alternatively, a metallic film, which serves as a compensation conductor having characteristics similar to the first metallic film 423, may be used. Similarly, it is preferable that the wiring pattern up to the bonding pad 422 be made of the second metallic film 424. Alternatively, a metallic film, which serves as a compensation conductor having characteristics similar to the second metallic film 424, may be used. The electrical connection from the wiring patterns of the temperature sensor further extends to a reference contact point disposed on the packaging board, not shown in the drawing, via the bonding pads 421 and 423, and temperature is then measured with a measuring tool on the packaging board.

For example, use of a 10% chromium (Cr)—nickel (Ni) alloy film as the positive (+) first metallic film 423, and 2% aluminum (Al)—Ni alloy film as the negative (−) second metallic film 424 implements a chrome-alumel thermocouple on the surface of the homogeneous material sphere 40 corresponding to type K of International Electrotechnical Commission (IEC). Vacuum evaporation or sputtering, using a metallic mask or using a lift off method, may selectively form the bonding pad 421, the wiring pattern from the bonding pad 421 up to the first metallic film 423, and the first metallic film 423. Similarly, vacuum evaporation or sputtering, using a metallic mask or using a lift-off method, may selectively form the bonding pad 422, the wiring pattern from the bonding pad 422 up to the second metallic film 424, and the second metallic film 424. In particular, when using a metallic mask, patterns of the bonding pad 421, wiring between the bonding pad 421 and the first metallic film 423, the first metallic film 423, and patterns of the bonding pad 422, wiring between the bonding pad 422 and the second metallic film 424, and the second metallic film 424 may be easily formed by shifting the location of the same metallic mask against the homogeneous material sphere 40.

The rectangular patterns of the first metallic film 423 and the second metallic film 423 having a thickness of approximately 50 nanometers to 300 nanometers, and a side length of approximately 0.5 millimeter to two millimeters should be formed. For example, at an ambient temperature of 23 degrees centigrade, the increase in the temperature of a sensor head of approximately 0.08 degree centigrade is measured, when high frequency burst signals of 45 MHz with 100 microseconds are irradiated to the sensor head at 1 KHz, employing a temperature sensor encompassing the first metallic film 423 made of 10% Cr—Ni alloy film having a side of approximately one millimeter and a thickness of approximately 100 nanometers, and the second metallic film 424 made of 2% Al—Ni alloy film having a side of approximately one millimeter and a thickness of 100 nanometers, the first metallic film 423 and the second metallic film 424 are stacked at mutually displaced locations. On the other hand, according to a measurement method using a wire-type chrome-alumel thermocouple in point-contact with the surface of the homogeneous material sphere 40, with a detection sensitivity of 0.03 degrees, a change of 0.08 degrees cannot be measured. As described above, the temperature sensor shown in FIG. 12B can measure temperature without delay as opposed to the case of measuring the surface temperature of the homogeneous material sphere 40 by contacting an independent thermocouple with the surface of the homogeneous material sphere 40.

FIG. 12C shows an exemplary sensor head using the resistance-thermometer type temperature sensor 42. In FIG. 12C, a resistance-detection pattern 425 is delineated on at least a part of the orbital band B over the surface of the homogeneous material sphere 40. As with FIG. 12B, the interdigital transducer 21 is formed on a part of the orbital band B and is connected to the bonding pads 211 and 212 in FIG. 12C. The interdigital transducer 21 is configured to be connected to the high frequency generator and the detection/output unit on the packaging board, omitted in the drawing, via the bonding pads 211 and 212.

The resistance-detection pattern 425 may be made of materials having characteristic such that resistance changes with temperature, such as a metallic thin film. By measuring the change in resistance of the resistance-detection pattern 425, the surface temperature of the homogeneous material sphere 40 is directly measured as with the thermocouple. To increase the change in resistance of the resistance-detection pattern 425, the resistivity of the material of the resistance-detection pattern 425 should be increased, the film thickness of the resistance-detection pattern 425 should be decreased, the line width of the resistance-detection pattern 425 should be decreased, or the entire length of the resistance-detection pattern 425 should be increased. In FIG. 12C, the resistance-detection pattern 425 is formed with a meander line, increasing the entire length. It is preferable that a single-layer thin film implements the resistance-detection pattern 425 so as not to prevent the surface acoustic wave from revolving along the orbital band B

For example, when a fine pattern of a thin platinum (Pt) film is used as the resistance-detection pattern 425, the platinum thin film thickness should be approximately 50 nanometers to 400 nanometers, more preferably 150 nanometers to 300 nanometers. Vacuum evaporation or sputtering using a metallic mask or using a lift-off method can delineate the fine pattern of the thin platinum thin film 425.

Although, it is preferable that the wiring pattern of the temperature sensor up to the bonding pad 421 shown in FIG. 12C is made of the same material as the resistance-detection pattern 425, alternatively, a metallic film having high electric conductivity such as aluminum (Al), gold (Au), and copper (Cu) can be used for the material of the wiring pattern. The wiring pattern extends to a packaging board, not shown in the drawing, via the bonding pads 421 and 423, and temperature is then measured with a measuring tool on the packaging board.

As shown in FIG. 12C, formation of the resistance-detection pattern 425 on the orbital band B for the surface acoustic wave facilitates direct and most accurate measurement of the temperature of the surface, over which the surface acoustic wave orbit, and does not prevent the surface acoustic wave from orbiting therearound.

The resistance-detection pattern 425 may be made of, for example, a thin platinum film having a width of approximately 0.2 millimeter and a thickness of approximately 200 nanometers, formed as a meander line turning back eight times. The entire length of the meander line is 3.76 millimeters. When measuring change in resistance using the resistance-detection pattern 425, the resistivity measures 1.3851/100 degrees centigrade (corresponding to JIS C 1604-1997), which means sufficient measurement sensitivity.

As to a portion of the platinum resistance-detection pattern 425 overlapping on the orbital path, it is well known from ‘GALLIUM NITRIDE INTEGRATED GAS/TEMPERATURE SENSORS FOR FUEL CELL SYSTEMS’, Hydrogen, Fuel Cells, and Infrastructure Technologies, FY2003 Progress Report that the platinum film is also elastically influenced by adsorption of hydrogen. In addition, when converting the changes in orbiting speed of the surface acoustic wave to hydrogen densities, calibration should be carried out considering the influence of the platinum resistance-detection pattern 425, because the dependency of the platinum resistance-detection pattern 425 on temperature is influenced by resistance of the palladium (Pd) film (or palladium alloy film).

As another countermeasure, formation of a hydrogen impermeable film between the platinum film and the palladium film (or palladium alloy film) is effective for suppressing the influence of the hydrogen density on temperature measurement using the platinum resistance-detection pattern 425.

(EIGHTH EMBODIMENT)

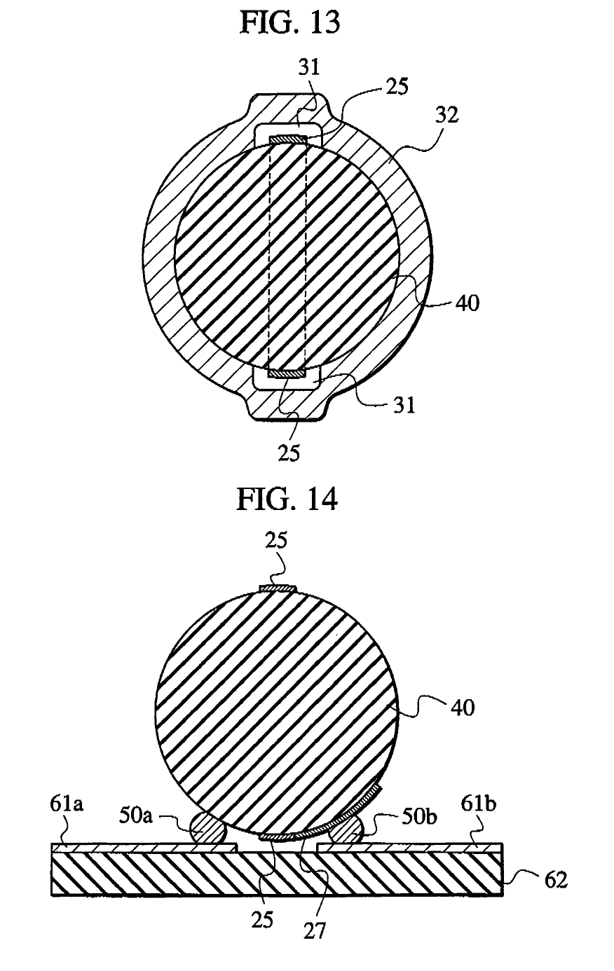

As shown in FIG. 13, a sensor head according to the eighth embodiment of the present invention includes a cover 32 on a homogeneous material sphere 40 so as to implement a cavity 31 over an orbital band B of the homogeneous material sphere 40. The cover 32 should be made of mesh metallic material or porous material to provide gas permeability. In addition, in the case of gas having extremely high permeability such as hydrogen, use of a film having a thickness of several micrometers can establish effectiveness of removing particles. The diameter of a hole allowing transmission of gas should be determined to be sufficiently smaller than the wavelength of the surface acoustic wave propagating on the surface of the homogeneous material sphere 40.

Existence of the cover 32 prevents influence on propagation characteristic of the surface acoustic wave due to large particles adhered to the orbital band B for the surface acoustic wave, thereby preventing measurement error. In other words, the sensor head according to the eighth embodiment of the present invention prevents the sensor head characteristics from degrading due to adhesion of particles in the measurement environment.

Needless to say, a structure of allowing gas flow only on the orbital band B for the surface acoustic wave by providing a gas inlet and a gas outlet in respective portions of the cover 32 may be available.

(NINTH EMBODIMENT)

As shown in FIG. 14, a sensor unit according to a ninth embodiment of the present invention encompasses a packaging board 62 on which a three-dimensional base body 40 is mounted, a high frequency generator (not shown in the drawing), which is allocated on the packaging board 62 and feeds a high frequency electric signal to an electroacoustic transducer (not shown in the drawing), a detection/output unit (not shown in the drawing), which is allocated on the packaging board 62 and measures a high frequency electric signal pertaining to propagation characteristic of the surface acoustic wave from the electroacoustic transducer, a first board wiring 61a, which is delineated on the surface of the packaging board 62 and electrically connected to the high frequency generator, a second board wiring 61b, which is delineated on the surface of the packaging board 62 and electrically connected to the detection/output unit, and conductive connectors 50a and 50b, which electrically connect the first board wiring 61a and the second board wiring 61b to the electroacoustic transducer, respectively.

The electroacoustic transducer is not shown in the drawing; however, it may be easily understood from the structure of the sensor head according to the first to eighth embodiments described above. In other words, the sensor unit according to the ninth embodiment is an assembly which mounts one of the sensor heads described in the first to eighth embodiments on the parallel-plate packaging board 62 using metallic bumps 50a and 50b as the conductive connectors 50a and 50b. More specifically, the board wirings 61a and 61b are delineated on the packaging board 62, and one of the sensor heads described in the first to eighth embodiments is mounted on the board wirings 61a and 61b using the metallic bumps 50a and 50b.

The metallic bumps 50a and 50b may be solder balls, gold (Au) bumps, silver (Ag) bumps, copper (Cu) bumps, nickel/gold (Ni—Au) bumps, or nickel/gold/indium (Ni—Au—In) bumps. The solder balls may be made of a tin-lead eutectic solder (Sn:Pb=6:4) having a diameter of 100 micrometers to 250 micrometers and a height of 50 micrometers to 200 micrometers. Alternatively, a tin-lead eutectic solder (Sn:Pb=5:95) may be available, Combination of thermocompression bonding and ultrasonic vibration, or thermal melting may be used for bonding.

The packaging board 62 may be made of an organic synthetic resin material or an inorganic material such as ceramics or glass. The organic synthetic resin material may be phenol resin, polyester resin, epoxy resin, polyimide resin, or fluorocarbon resin. A base material, which serves as the center core for forming into a tabular shape, may be paper, a glass fabric, or a glass base material. A typical organic substrate material is ceramics. In addition, if a high heat dissipation characteristic is required, a metallic substrate can be employed, and if a transparent substrate is required, glass can be employed. The ceramics substrate material may be alumina (Al₂O₃), mullite (3Al₂O₃.2SiO₂), beryllia (BeO), aluminum nitride (AlN), or silicon nitride (SiC). Alternatively, a multi-layered metallic base substrate (metallic insulator substrate) structured by stacking a polyimide resin plate having high heat resistance on a metal such as iron or copper may be available. The board wirings 61a and 61b may be a thin metallic film such as gold, copper, or aluminum.

Since the orbital band B for the surface acoustic wave may be formed only in the vicinity of the equator, the metallic bumps 50a and 50b may be connected to anywhere except for the orbital band B so as to fix the homogeneous material sphere 40 to the packaging board 62. Metallic pads (bonding pads) for attaching the metallic bumps 50a and 50b are provided on an area other than the orbital band B for the surface acoustic wave. However, to supply power to an interdigital transducer from a high frequency generator provided on the packaging board 62 side, and transfer a high frequency electric signal from the interdigital transducer to a detection/output unit provided on the packaging board 62 side, an electrode interconnect 27 is formed extending from the interdigital transducer, and metallic pads (bonding pads) are formed on the terminals of the electrode interconnect 27. Note that the high frequency generator and the detection/output unit are not shown in FIG. 14; however, they are provided on the packaging board 62 of the sensor unit according to the ninth embodiment. The first board wiring 61a is electrically connected to the high frequency generator, and the second board wiring 61b is electrically connected to the detection/output unit. The metallic bumps 50a and 50b serving as the conductive connectors 50a and 50b electrically connect the respective first and the second board wirings 61b to the electroacoustic transducer (not shown in the drawing). Alternatively, instead of such “a system-on-package”, in which the high frequency generator and the detection/output unit are merged on the packaging board 62, the high frequency generator and the detection/output unit may be located outside the packaging board 62 to be connected.

On the other hand, when circuits such as a high frequency generator and a detection/output unit are integrated onto the homogeneous material sphere 40, because measured results may be directly obtained on the homogeneous material sphere 40, the electrode interconnect 27 extending from the interdigital transducer to the metallic pads (bonding pads) can be omitted.

Note that it is preferable that target measurement gas should flow in parallel with the plane of the surface of the packaging board 62, according to a sensor unit assembling method of the ninth embodiment.

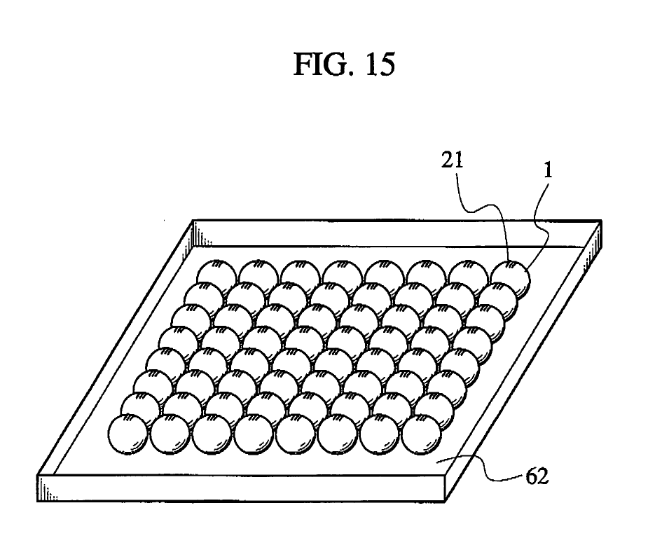

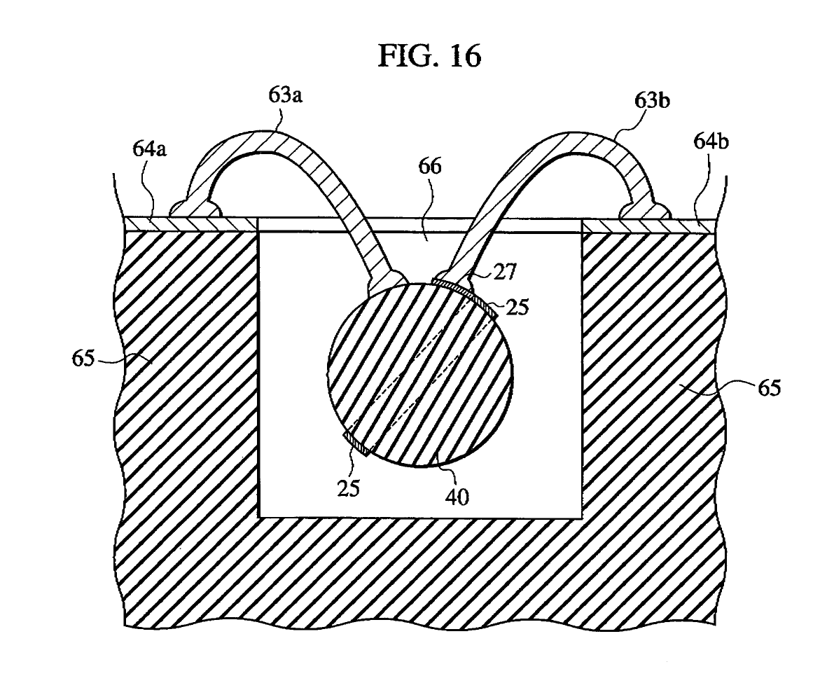

FIG. 15 schematically shows an exemplary structure of multiple sensor heads (spherical surface acoustic wave devices) arranged in an array using the sensor unit assembling architecture shown in FIG. 14. A plurality of sensor heads (spherical surface acoustic wave devices) 1 are arranged on the packaging board 62 in an array. The interdigital transducers 21 used for exciting and receiving the surface acoustic wave are connected to board wirings, not shown in the drawing, on the packaging board 62 via metallic bumps, not shown in the drawing, on the back side of the respective homogeneous material spheres 40, respectively. The spherical surface acoustic wave devices 1 have respective different sensitive films, allowing measurement of different kinds of gas molecules.

(TENTH EMBODIMENT)

As shown in FIG. 16, a sensor unit according to a tenth embodiment of the present invention encompasses a packaging board 62 on which a three-dimensional base body 40 is mounted, a high frequency generator (not shown in the drawing), which is allocated on the packaging board 62 and feeds a high frequency electric signal to an electroacoustic transducer (not shown in the drawing), a detection/output unit (not shown in the drawing), which is allocated on the packaging board 62 so as to measure the high frequency electric signal pertaining to the propagation characteristic of the surface acoustic wave from the electroacoustic transducer, a first board wiring 64a, which is delineated on the surface of the packaging board 62 and electrically connected to the high frequency generator, a second board wiring 64b, which is delineated on the surface of the packaging board 62 and electrically connected to the detection/output unit, and conductive connectors 63a and 63b, which electrically connect the first board wiring 64a and the second board wiring 64b to the electroacoustic transducer, respectively.

The electroacoustic transducer is not shown in the drawing; however, it may be easily understood from the structure of the sensor head according to the first to eighth embodiments described above.

The configuration of the sensor unit according to the tenth embodiment is different from the sensor unit according to the ninth embodiment in that the sensor unit is mounted on the parallel-plate packaging board 62 via bonding wires 63a and 63b, which serve as the conductive connectors 63a and 63b.

The feature of the sensor unit according to the tenth embodiment inheres in the packaging board 62 made of epoxy resin, which has a top surface (first principal surface) being provided with a cavity 66 larger in diameter than a homogeneous material sphere 40. The board wirings 61a and 61b are delineated on the periphery of the cavity 66 on the top surface (first principal surface) of the packaging board 62. The homogeneous material sphere 40 is electrically connected to the board wirings 61a and 61b via the bonding wires 63a and 63b, and is suspended and retained in the cavity 66.

The bonding wires 63a and 63b may be a thin wire made of gold, aluminum, or copper. In particular, when using a flexible material such as a gold wire, solid metal such as chromium may be deposited on the surface of the gold wire by plating after having assembled a package of the sensor unit according to the tenth embodiment, thereby improving mechanical strength of the gold wire. Since the orbital band B for the surface acoustic wave may be formed only in the vicinity of the equator, the homogeneous material sphere 40 may be fixed to anywhere except for the orbital band B. The bonding pads for attaching the bonding wires 63a and 63b are allocated outside the orbital band B for the surface acoustic wave.

Although the high frequency generator and the detection/output unit are not described with the sensor unit according to the tenth embodiment, the high frequency generator and the detection/output unit may be formed on the packaging board 62 so as to implement a system-on-package, or alternatively, the high frequency generator and the detection/output unit may be located outside the packaging board 62 to be connected with. When circuits for the high frequency generator and the detection/output unit are integrated onto the homogeneous material sphere 40, measured results may be directly obtained on the homogeneous material sphere 40. Note that it is preferable that target measurement gas should flow perpendicular to the plane of the top surface of the packaging board 62 so that target measurement gas can pass through the cavity 66 according to the sensor unit assembling architecture of the tenth embodiment.

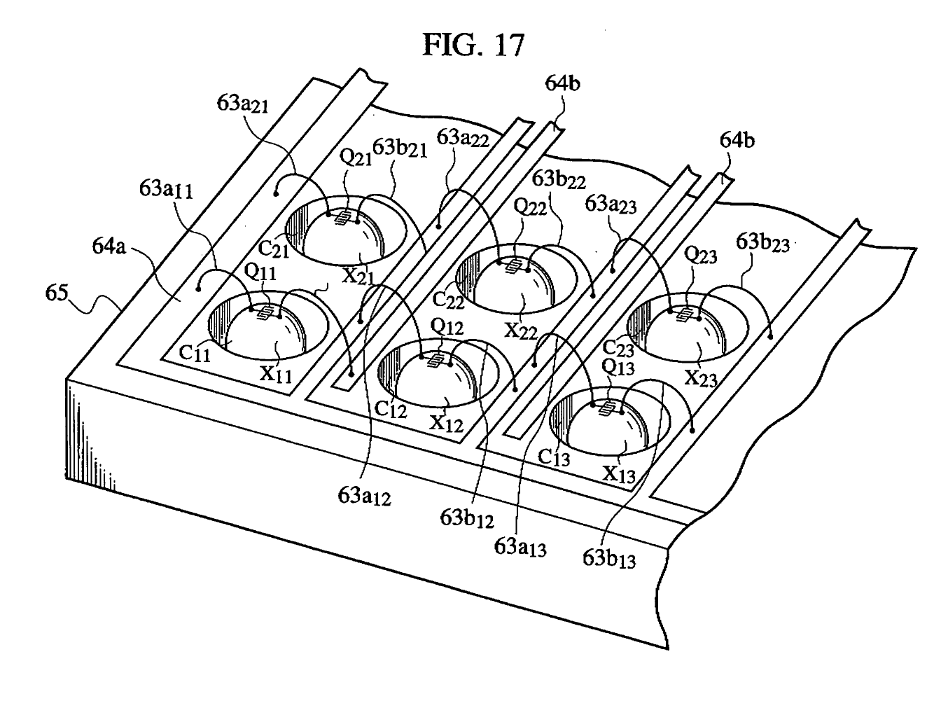

FIG. 17 schematically shows an exemplary structure of multiple spherical surface acoustic wave devices (sensor heads) arranged in an array using the assembling architecture shown in FIG. 16. A plurality of spherical surface acoustic wave devices (sensor heads) X₁₁, X₁₂, X₁₃, X₂₁, X₂₂, X₂₃, . . . are arranged in respective cavities C₁₁, C₁₂, C₁₃, C₂₁, C₂₂, C₂₃ on a packaging board 65 in an array. Interdigital transducers Q₁₁, Q₁₂, Q₁₃, Q₂₁, Q₂₂, Q₂₃, . . . used for exciting and receiving the surface acoustic waves are connected to board wiring 64a or 64b on the packaging board 65 via metallic wires 63a₁₁, 63a₁₂, 63a₁₃, 63a₂₁, 63a₂₂, 63a₂₃, 63b₁₁, 63b₁₂, 63b₁₃, 63b₂₁, 63b₂₂, 63b₂₃, . . . The respective spherical surface acoustic wave devices X₁₁, X₁₂, X₁₃, X₂₁, X₂₂, X₂₃ . . . have different sensitive films, allowing measurement of different kinds of gas molecules.

(ELEVENTH EMBODIMENT)

According to the sensor head of the first to eighth embodiments, a case of defining an orbital band B on the outer peripheral surface of the three-dimensional base body 40 has been described. Alternatively, the orbital band may be defined on the surface of the inner wall of the cavity of the three-dimensional base body.

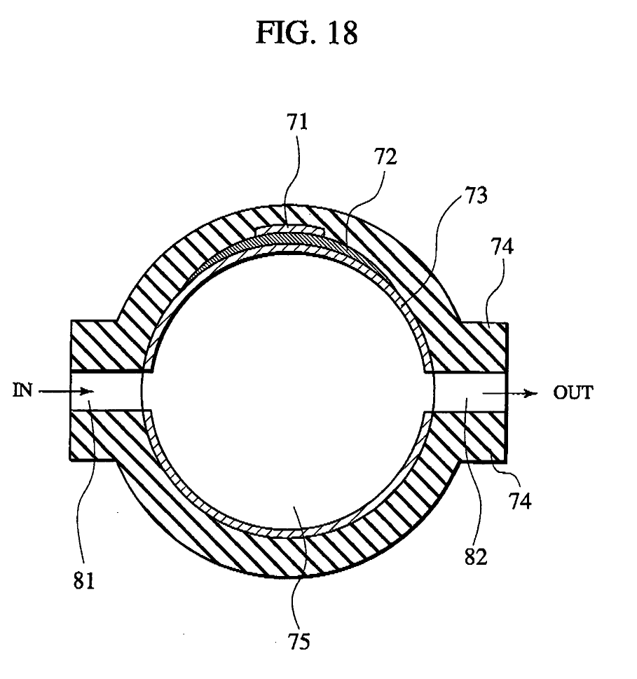

As shown in FIG. 18, a sensor head according to the eleventh embodiment of the present invention implements a cavity (sensing cavity) 75 by a spherical interior face of a case body 74, which serves as a three-dimensional base body, made of a material having homogeneous elastic characteristics. An orbital band is defined on the interior face of the sensing cavity 75. In other words, according to the sensor head of the eleventh embodiment, a sensitive film 73 is formed on the interior face of the sensing cavity 75, and a thin piezoelectric film 72 and an interdigital transducer 71 are formed on a part of the interface between the sensitive film 73 and the case body 74.

When the orbital band defined on the interior face of the sensing cavity 75 of the sensor head according to the eleventh embodiment is used, a similar phenomenon of multiple roundtrips of a surface acoustic wave may occur as with the sensor heads described in any of the first to eighth embodiments.

A structure of the sensor head according to the eleventh method may be fabricated using a method such as electroforming. In other words, using a silicon sphere 40 as an electroforming mold (master mold) for fabricating the sensor heads described in any of the first to eighth embodiments, the sensitive film 73, the thin piezoelectric film 72, the interdigital transducer 71, and the case body 74 are deposited in this order, which is reverse to the order according to the sensor head fabrication method described in any of the first to eighth embodiments. Afterwards, the silicon sphere 40 used as the electroforming mold (master mold) is then removed through etching using xenon difluoride (XeF₂), thereby easily fabricating the sensing cavity 75. Since XeF₂ is used to etch only silicon and has higher selectivity against other materials, aforementioned materials described in any of the first to eighth embodiments may be used, as they are, as the sensitive film 25, the thin piezoelectric film, and the interdigital transducer 21.

Since the sensor head of the eleventh embodiment has a surface acoustic wave propagating on the interior face of the sensing cavity 75, it is not influenced by particles significantly. In addition, taking only a small amount of target measurement gas as a sample and making it flow from the gas inlet 81 to the gas outlet 82 in the sensing cavity 75 is possible, thereby achieving high sensitivity, high responsibility and high efficiency, while facilitating reduction in size.

(OTHER EMBODIMENTS)

While the present invention has been described according to the aforementioned first to eleventh embodiments, the description and drawings serving as part of this disclosure are not to be construed as limiting the present invention. This disclosure makes dear a variety of alternative embodiments, working examples, and operational techniques for those skilled in the art.

In the aforementioned description of the sensor head according to the first to eleventh embodiments, the case of using a homogeneous material sphere 40 as a ‘three-dimensional base body’ is exemplified. However, the three-dimensional base body is not limited to a sphere. Alternatively, it may be a beer barrel shape, a cocoon shape, or a rugby ball shape as long as lower accuracy of the sensor can be permitted. In other words, collimated surface acoustic wave may perform multiple roundtrips as long as the ‘three-dimensional base body’ of the present invention has, in the vicinity of the orbital band, a first curvature in a first principal direction along the central line of the orbital band and a second curvature in a second principal direction perpendicular to the first principal direction. The width of the orbital band having the second curvature is determined based on the second principal direction, the radius of the curvature, and the surface acoustic wave wavelength. For example, if the radius of the curvature in the second principal direction is approximately five millimeters and the frequency is 45 MHz, the width of the orbital band is approximately seven fiftieth of the radius of the curvature in the second principal direction.

Therefore, even if a polyhedron shape is provided in an area far from the width of the orbital band in the second principal direction, with such topology a collimated surface acoustic wave can perform multiple roundtrips.

Furthermore, while the three-dimensional structure in real space has been described as the structure of the sensor head according to the first to eleventh embodiments, a structure equivalent to the curved surface in real space may be achieved by gradually changing elastic constant or related parameters in elastic tensor space, alternatively. For example, the same effectiveness as the spherical surface may be achieved by gradually changing the elastic characteristics with distance from the center of the orbital band along the second principal direction.

As described above, needless to say, the present invention includes sensor heads and the like according to various embodiments not described herein. Accordingly, the technical scope of the present invention is only defined by the claims that appear appropriate from the above explanation.

### INDUSTRIAL APPLICABILITY

The present invention provides a mechanically robust sensor head having high sensitivity and high-speed responsibility, a gas sensor using the sensor head, and a sensor head assembling the sensor unit, allowing analysis of various gas components in the atmosphere or ambient of vapor-phase chemical process.

More specifically, the present invention can be adapted for use in home gas alarms, industrial gas alarms, and portable gas alarms as long as an appropriate sensitive film is selected. In addition, the present invention can be adapted for use in odor sensors, and air environment measurement systems.

Moreover, as long as an appropriate sensitive film is selected, the present invention can be applied to fields of boilers and automobile industry such as an air-fuel ratio control apparatus, a catalytic apparatus, an exhaust cleaning apparatus, and a combustion apparatus; and field of gas density detector, which is employed in chemical plants and semiconductor plants. Furthermore, the present invention can be adapted for use in irregularity detecting systems including food quality control sensors.

1. A sensor head, comprising:
a three-dimensional base body having a curved surface allowing definition of a circular orbital band;
an electroacoustic transducer arranged on the orbital band of the three-dimensional base body, configured to excite surface acoustic wave to perform multiple roundtrips along the orbital band; and
a sensitive film at least a part of which is formed on at least a part of the orbital band of the three-dimensional base body, configured to react with a specific gas molecule.

2. The sensor head of claim 1, wherein the orbital band is defined on the surface of the outer periphery of the three-dimensional base body.

3. The sensor head of claim 1, wherein the orbital band is defined on the interior face of a cavity of the three-dimensional base body.

4. The sensor head of claim 1, wherein the thickness of the sensitive film is 100 nanometers or less.

5. The sensor head of claim 1, wherein the thickness of the sensitive film is one five hundredth of the wavelength of the surface acoustic wave or less.

6. The sensor head of claim 1, wherein the thickness of the sensitive film is one thousandth of the wavelength of the surface acoustic wave or less.

7. The sensor head of claim 1, wherein the sensitive film is a film containing palladium.

8. The sensor head of claim 1 further comprising a temperature sensor on the surface of the three-dimensional base body configured to measure the surface temperature.

9. The sensor head of claim 8, wherein the temperature sensor includes a resistance-detection pattern provided on at least a part of the orbital band.

10. A gas sensor, comprising:
a three-dimensional base body having a curved surface allowing definition of a circular orbital band;
an electroacoustic transducer arranged on the orbital band of the three-dimensional base body, configured to excite surface acoustic wave to perform multiple roundtrips along the orbital band and generate a high frequency electric signal from the surface acoustic wave being experienced the multiple roundtrips;
a sensitive film at least a part of which is formed on at least a part of the orbital band of the three-dimensional base body and configured to react with a specific gas molecule;
a high frequency generator configured to feed a high frequency electric signal to the electroacoustic transducer; and
a detection/output unit configured to measure the high frequency electric signal pertaining to propagation characteristic of the surface acoustic wave from the electroacoustic transducer.

11. The gas sensor of claim 10, wherein the high frequency generator and the detection/output unit are integrated onto the three-dimensional base body.

12. The gas sensor of claim 10 further comprising a temperature sensor on the surface of the three-dimensional base body configured to measure the surface temperature.

13. The gas sensor of claim 12, wherein the temperature sensor includes a resistance-detection pattern delineated on at least a part of the orbital band.

14. A sensor unit, comprising:
a three-dimensional base body having a curved surface allowing definition of a circular orbital band;
an electroacoustic transducer arranged on the orbital band of the three-dimensional substrate and excite surface acoustic wave to perform multiple roundtrips along the orbital band and generate a high frequency electric signal from the surface acoustic wave being experienced the multiple roundtrips;
a sensitive film at least a part of which is formed on at least a part of the orbital band of the three-dimensional base body and configured to react with a specific gas molecule;
a packaging board on which the three-dimensional base body is mounted;
a high frequency generator arranged on the packaging board and to feed a high frequency electric signal to the electroacoustic transducer;
a detection/output unit arranged on the packaging board and measure the high frequency electric signal pertaining to the propagation characteristics of the surface acoustic wave from the electroacoustic transducer;
a first board wiring arranged on the surface of the packaging board and be electrically connected to the high frequency generator;
a second board wiring arranged on the surface of the packaging board and be electrically connected to the detection/output unit; and
conductive connectors configured to electrically connect the first and the second board wiring to the electroacoustic transducer, respectively.

15. The sensor unit of claim 14 further comprising a temperature sensor on the surface of the three-dimensional base body configured to measure the surface temperature.

16. The sensor unit of claim 15, wherein the temperature sensor includes a resistance-detection pattern delineated on at least a part of the orbital band.

17. A sensor unit, comprising:
a three-dimensional base body having a curved surface allowing definition of a circular orbital band;
an electroacoustic transducer arranged on the orbital band of the three-dimensional substrate and excite surface acoustic wave to perform multiple roundtrips along the orbital band and generate a high frequency electric signal from the surface acoustic wave being experienced the multiple roundtrips;
a sensitive film at least a part of which is formed on at least a part of the orbital band of the three-dimensional base body and configured to react with a specific gas molecule;
a high frequency generator configured to be integrated on the three-dimensional base body and to feed a high frequency electric signal to the electroacoustic transducer;
a detection/output unit integrated on the three-dimensional base body and configured to measure the high frequency electric signal pertaining to the propagation characteristics of the surface acoustic wave from the electroacoustic transducer;
a packaging board on which the three-dimensional base body is mounted;
a board wiring arranged on the surface of the packaging board; and
a conductive connector configured to electrically connect the first interconnect to the detection/output unit.

18. The sensor unit of claim 17 further comprising a temperature sensor on the surface of the three-dimensional base body configured to measure the surface temperature.

19. The sensor unit of claim 18, wherein the temperature sensor includes a resistance-detection pattern delineated on at least a part of the orbital band.
